(19) United States
(12) Patent Application Publication
(10) Pub. No.: US 2022/0129973 A1
(43) Pub. Date: Apr. 28, 2022

(54) Image Modification to Generate Ghost Mannequin Effect in Image Content

(71) Applicant: Adobe Inc., San Jose, CA (US)

(72) Inventors: Ajay Bedi, Hamirpur (IN); Rishu Aggarwal, Rohini (IN)

(21) Appl. No.: 17/077,739

(22) Filed: Oct. 22, 2020

(51) Int. Cl. G06Q 30/06; G06K 9/62

(52) U.S. Cl. CPC G06Q 30/0643; G06K 9/6232; G06K 9/6202

(57) ABSTRACT

An image modification system receives image features of a base image and an additional image. The base image and the additional image depict an apparel item displayed on a mannequin. A first feature pair from the base image and a second feature pair from the additional images are determined. A first distance is calculated between the first feature pair and a second distance is calculated between the second feature pair. Based on a ratio including the first and second distances, a matching relationship between the first and second feature pairs is determined. A pixel of the base image is identified within an image area occluded by the mannequin. Based on the matching relationship, image data is identified for a corresponding additional pixel from the additional image. A modified base image including a ghost mannequin effect is generated by modifying the pixel to include the image data of the additional pixel.

### TECHNICAL FIELD

This disclosure relates generally to the field of digital image editing, and more specifically relates to automatic modification of mannequin areas in a digital image.

### BACKGROUND

An online distribution environment can include technological tools to assist users who wish to provide products or services via the online distribution environment. In some cases, the technological tools include image editing tools that are capable of modifying digital photographs. For example, a user who wishes to provide apparel or fashion items via the online distribution environment could use the image editing tools to modify a digital photograph depicting the apparel items being provided.

A contemporary technical approach to provide high-quality photographs of apparel items is the “ghost mannequin” effect, also known as the “invisible mannequin,” or “hollow man” effect. Applying a ghost mannequin effect to apparel images can produce lifelike images that allow a customer to focus on the product. However, contemporary techniques to apply a ghost mannequin effect are manual and tedious, often requiring a high amount of experience and manual labor, and include time-consuming use of image editing tools. Additionally or alternatively, contemporary tools to automatically remove background areas of an image do not accurately identify or remove image areas of a mannequin (or model), and manual effort is still required to correctly and accurately remove the mannequin image areas and produce the ghost mannequin effect.

### SUMMARY

According to certain embodiments, an image modification system receives a base image and an additional image that both depict an apparel item. The image modification system calculates a first distance between a pair of image features from the base image and a second distance between a pair of image features from the additional image. The image modification system determines, based on the first and second distances, that a matching relationship exists between the first pair of the image features and the second pair of the additional image features. The image modification system also identifies, in the base image, a set of one or more pixels located within a mannequin image area or an occluded image area. The image modification system determines, based on the matching relationship, that the identified pixel set corresponds to an additional set of one or more pixels in the additional image. The image modification system modifies the base image to include a ghost mannequin effect by modifying the pixel set from the base image to include image data of the pixel set from the additional image. For example, the image modification system generates occlusion image data from the corresponding pixel set of the additional image, and modifies the pixel set of the base image to include the occlusion image data.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings, where:

FIG. 1 is a diagram depicting an example of a computing environment in which an image modification system modifies one or more digital images to include a ghost mannequin effect, according to certain embodiments;

FIG. 2 is a diagram depicting an example of an image modification system that is configured to generate a modified base image based on an image and one or more additional images, according to certain embodiments;

FIG. 3 is a flowchart depicting an example of a process for applying a ghost mannequin effect to image data, according to certain embodiments;

FIG. 4 is a diagram depicting an example of image features by which an image modification system can determine one or more matching relationships, according to certain embodiments;

FIG. 5 is a diagram depicting an example of occluded pixels that are modified by an image modification system to include image data from additional pixels, according to certain embodiments;

FIG. 6 is a flowchart depicting an example of a process for applying a ratio test technique based on multiple image features, according to certain embodiments;

FIG. 7 is a diagram depicting an example of an image modification system that is configured to generate a modified base image based on a selected image area and one or more additional images, according to certain embodiments;

FIG. 8 is a diagram depicting an example of occluded pixels for a selected image area depicting a selected image item, according to certain embodiments;

FIG. 9 is a flowchart depicting an example of a process for applying a ghost mannequin effect to selected image data of a digital image, according to certain embodiments; and

FIG. 10 is a block diagram depicting an example of a computing system for implementing an image modification system, according to certain embodiments.

### DETAILED DESCRIPTION

As discussed above, prior techniques for automatically generating a ghost mannequin effect in digital images do not provide high-quality digital images or accurate modification of mannequin image areas. Furthermore, manual techniques for generating a ghost mannequin effect are labor-intensive, and may require a large amount of time and effort by a technician who is trained in image editing. These issues can be addressed by certain embodiments described herein. For instance, certain embodiments involve an image modification system that accurately applies a ghost mannequin effect to image content from a base image by determining matching relationships between image features of the base image and image features of one or more additional images. Such an image modification system utilizes these feature-mapping techniques to generate a modified base image by combining image content of the base image and image content of the additional images. The image modification system generates the modified base image automatically, without requiring labor-intensive efforts from a user of the image modification system.

The following example is provided to introduce certain embodiments of the present disclosure. In this example, an image modification system receives a base image and one or more additional images. The base images depicts a T-shirt in a certain position on a mannequin, whereas the additional images depict the T-shirt without the mannequin or depict the T-shirt in a different position on the mannequin. The image modification system identifies matching relationships between image features of the base image and additional image features of the additional images. The matching relationships are determined based on distances between features of the base image and the additional images. For example, the image modification system identifies a set of features of the base image depicting a colorful pattern of the T-shirt and a set of additional features of the additional image that also depict the colorful pattern. The image modification system computes one or more distances among the base image features, and one or more additional distances among the additional image features. For instance, a distance for image features that depict the colorful pattern indicates finding a difference between the pixel coordinates for a first part of the color pattern (e.g., depicted by a first feature) and the pixel coordinates for a second part of the color pattern (e.g., depicted by a second feature), thereby providing a distance, in pixels, between different parts of the color pattern that are depicted by different features. By comparing the distances of the base image features to the additional distances of the additional image features, the image modification system determines that the features match, e.g., depict the same colorful pattern. For instance, the image modification system calculates one or more ratios using the distances and the additional distances, and compares the ratios to a similarity threshold. Feature sets having a ratio that exceeds the similarity threshold are identified by the image modification system as having a matching relationship. In the example involving the color T-shirt, a first ratio for the base image is determined by dividing distances between multiple parts of the color pattern in the base image, such as distances from a first feature to a second feature, and from the second feature to a third feature. A second ratio for the additional image is determined by dividing distances between multiple parts of the color pattern in the additional image. The image modification system compares the first and second ratios. If the comparison of the first and second ratios is within a similarity threshold, then the features more likely depict a same part of the color pattern in both images (i.e., the features of the color pattern have a matching relationship between the base and additional images). If the comparison of the first and second ratios does not meet the similarity threshold, then the features more likely depict different parts of the color pattern in the base and additional images (i.e., the features of the color pattern do not have a matching relationship).

In some embodiments, the image modification system also generates a modified base image that includes a ghost mannequin effect applied to image content of the base image. For instance, in the example involving images of a T-shirt, the image modification system identifies pixels that are occluded in the base image by a mannequin on which the T-shirt is displayed. The image modification system also determines, for the occluded pixels, corresponding pixels from the additional images. The correspondence between the occluded pixels and the additional pixels is determined, for example, based on the matching relationships identified by the feature-mapping module. Continuing with the example features that depict the colorful pattern, a correspondence is identified between an occluded pixel that is located close to the colorful pattern of the base image, and an additional pixel that is located close to the colorful pattern of the additional image. The image modification system identifies the location of the additional pixel using locations of pixels that depict the colorful pattern in the base image features and the additional image features. Also, the image modification system identifies image data of the additional pixel, such as image data depicting a part of the T-shirt that is occluded by the mannequin in the base image. The image modification system generates the modified base image based on a combination of image data from the base image and additional image data from the additional pixel. For the example T-shirt images, the modified base image depicts the T-shirt from the base image combined with the image data of the additional pixel that depicted the occluded part of the T-shirt. In some cases, the modified base image depicts the T-shirt with a ghost mannequin effect, in which the T-shirt has a dimensional appearance, as if it were displayed on a mannequin, combined with areas of the T-shirt that were occluded by the mannequin in the base image, such as a collar area that would be behind a neck of the mannequin.

Certain embodiments described herein provide improved image modification techniques for applying a ghost mannequin effect to a digital graphical image. For instance, determining a matching relationship between image features of a base image and additional image features of an additional image involves applying particular rules, such as calculation of distances among multiple pairs of image features and a comparison of multiple distance ratios. Additionally or alternatively, determining a correspondence between a pixel of a base image and an additional pixel of an additional image involves applying additional rules, such as generating a homography transformation matrix that describes location transformations between pixels in the base image and additional pixels in the additional image. In some cases, the application of these rules achieves an improved technological result, such as more accurately generating an image with a ghost mannequin effect. In an additional improved technological result, the ghost mannequin effect is applied to the generated image with improved speed and efficiency, such as by reducing labor-intensive time and effort by a technician who is trained in image editing. Thus, embodiments described herein improve computer-implemented processes for generating an image with a ghost mannequin effect, thereby providing a more suitable solution for automating tasks previously performed by humans.

As used herein, the terms “ghost mannequin” and “ghost mannequin effect” refer to a visual appearance of an apparel item depicted in an image, in which the apparel item has a dimensional appearance and is depicted without a mannequin. In some cases, the dimensional appearance of the apparel item is formed in a shape of a mannequin. Additionally or alternatively, areas of the apparel item that would be behind (with respect to the image viewpoint) the form of a mannequin are visible with the applied ghost mannequin effect. For example, a ghost mannequin effect applied to an image of a T-shirt could depict the T-shirt formed in a shape of a mannequin, such as with fabric formed to accommodate a chest and shoulders, and with visibility of T-shirt areas that would have been behind the mannequin, such as collar or sleeve areas that might be occluded by a neck of arm of the mannequin. For illustration, and not by way of limitation, a ghost mannequin effect can also be called an “invisible mannequin effect” or a “hollow man effect.”

As used herein, the term “mannequin” refers to an object, or a graphical depiction of an object, that is capable of displaying an apparel item. As used here, a mannequin can include (without limitation) a human model (e.g., a professional clothing model), a realistic mannequin (e.g., a plastic mannequin formed to resemble a human body or body part), an abstract mannequin (e.g., a metal wireframe mannequin with a form dissimilar to a human body or body part), or any other suitable object or person suitable for displaying an apparel item. In some cases, a mannequin can occlude one or more areas of an apparel item depicted in an image, such as areas of the apparel item that are occluded by a head, a neck, a limb, a hand, or other portion of the mannequin. In some cases, the occluded areas of the apparel item are occluded in a particular image and visible in an additional image. For example, in a first example image depicting the apparel item from a frontal view while displayed on a mannequin, the mannequin could occlude areas of the apparel item that are behind (with respect to the frontal view) the mannequin neck and arms. In a second example image depicting the apparel item from a frontal view without the mannequin, the areas of the apparel item that were occluded in the first image could be visible, e.g., not occluded, in the second image.

As used herein, the terms “image” and “digital image” refer to graphical digital content that visually depicts a graphical representation of subject matter. For example, an image uses pixels or vector-based graphics to represent a depiction of subject matter (e.g., people, landscape, objects, animals). Examples of a digital image include, without limitation, a digitized photograph, an electronic version of a hand-drawn design, a graphic created with drawing software, or any other suitable graphical data that represents visual subject matter.

As used herein, the terms “feature” and “image feature” refer to a graphical quality of an image. An image can include features describing graphical qualities or contextual qualities of the image, such as brightness, contrast, color, directional edges (e.g., vertical, horizontal, diagonal edges), textures depicted in the image, image resolution, spatial relationships of depicted objects, semantic content, or other suitable features on a digital image. As used herein, the terms “vector” and “feature vector” refer to a quantitative representation of information describing image features.

As used herein, the term “neural network” refers to one or more computer-implemented networks capable of being trained to achieve a goal. Unless otherwise indicated, references herein to a neural network include one neural network or multiple interrelated neural networks that are trained together. In some cases, a neural network (or a component of a neural network) produces output data, such as data indicating image features, data indicating similarities or differences between images, a score associated with an image, or other suitable types of data. Examples of neural networks include, without limitation, a deep learning model, a deep ranking model, a convolutional neural network (CNN), a deep CNN, and other types of neural networks.

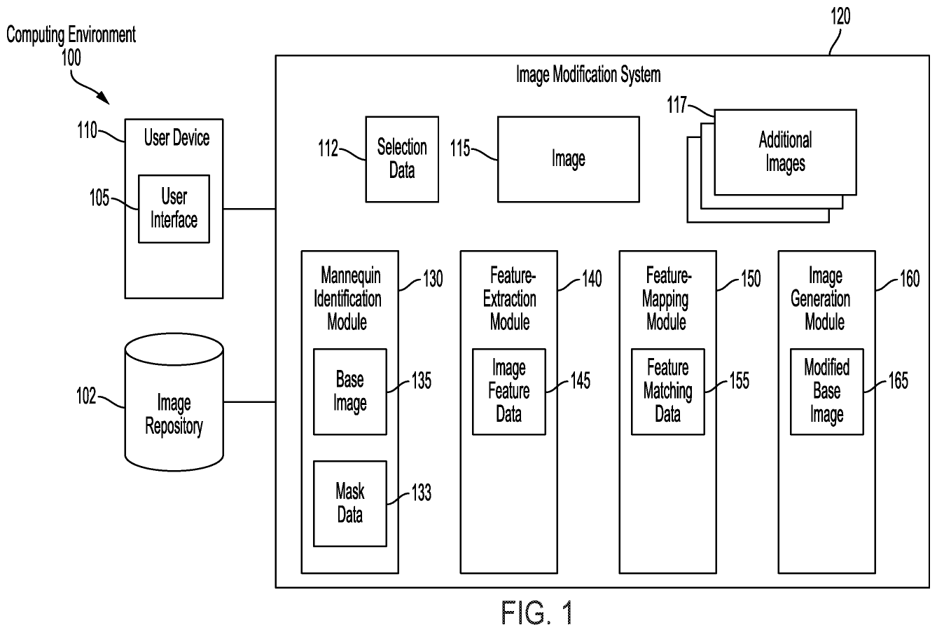

Referring now to the drawings, FIG. 1 is a diagram depicting an example of a computing environment 100, in which an image modification system 120 modifies one or more digital images to include a ghost mannequin effect. The computing environment 100 includes one or more of the image modification system 120, a user computing device 110, or an image repository 102. In some cases, the image modification system 120 could be included in, or otherwise capable of communicating with, an online distribution environment. For example, a person who wishes to provide images to the online distribution environment could access the image modification system 120, such as via the user device 110, to modify the images. For example, the person could provide to the image modification system 120 one or more images for modification to include a ghost mannequin effect. In some implementations, the image modification system 120 provides the modified images to one or more of the online distribution environment, the user device 110, or the image repository 102. In some cases, the image modification system 120 provides the modified images with improved efficiency or quality, as compared to contemporary techniques for adding a ghost mannequin effect to a digital image. For example, the person who wishes to provide the images to the online distribution environment can receive the modified images more efficiently (e.g., less time, reduced cost) by accessing the image modification system 120.

In some implementations, the image modification system 120 receives one or more digital images for modification, such as an image 115. Additionally or alternatively, the image modification system 120 receives one or more additional images 117. In some cases, the additional images 117 include image data that corresponds to content depicted in the image 115. The image modification system 120 receives the images 115 or 117 from, for instance, one or more of the user device 110 or the image repository 102. In some cases, the images 115 or 117 are indicated by selection data 112. In some cases, the image modification system 120 receives the selection data 112, such as from one or more of the user device 110 or the image repository 102. For example, the selection data 112 is generated by the user device 110, such as based on one or more inputs to a user interface 105 of the user device 110. Additionally or alternatively, the image repository 102 provides at least a portion of the selection data 112, such as data indicating one or more of the images 115 or 117. The selection data 112 includes computer-readable data indicating, for example, one or more digital images selected for modification to include a ghost mannequin effect. Additionally or alternatively, the selection data 112 includes computer-readable data indicating one or more digital images depicting content corresponding to the selected image, such as the additional images 117. Furthermore, the selection data 112 could include computer-readable data indicating one or more areas of the digital image 115 for generation of an additional image including a ghost mannequin effect. In some cases, the images 115 or 117 are received from the user device 110, such as a digital image uploaded by a user of the device 110. Additionally or alternatively, the images 115 or 117 are received from the image repository 102. For example, the selection data 112 could indicate one or more images, such as the image 115, that are selected from the image repository 102 for modification to include a ghost mannequin effect. In some cases, the image repository 102 is included in (or otherwise configured to communicate with) the online distribution environment.

In FIG. 1, the image 115 and the additional images 117 include digital image data, such as pixels, that depict one or more apparel items, such as items that could be worn or carried by a person. For example, the image 115 depicts an apparel item that is displayed by a mannequin. Additionally or alternatively, the additional images 117 depict additional content for the apparel item in the image 115, such as additional views of the item. In some cases, the depicted apparel items represent products or services available for distribution via the online distribution environment, such as clothing, jewelry, shoes, handbags, or other types of apparel items. For convenience, and not by way of limitation, the ghost mannequin effect and image modification techniques described herein are described with regards to apparel items, but other implementations are possible. For example, the described techniques could apply a ghost mannequin effect to an image depicting sporting equipment, toys, animal accessories (e.g., pet collars), or any other product or service that could be displayed or demonstrated via a mannequin.

In some implementations, the image modification system 120 includes one or more of a mannequin identification module 130, a feature-extraction module 140, a feature-mapping module 150, or an image generation module 160. Additionally or alternatively, one or more of the modules 130, 140, 150, or 160 perform one or more techniques related to modifying an image to include a ghost mannequin effect.

In FIG. 1, the mannequin identification module 130 identifies one or more areas of the image 115 that depict a mannequin, such as a mannequin wearing an apparel item. Additionally or alternatively, the mannequin identification module 130 generates mask data 133 that indicates a location (or locations) of the identified mannequin image areas. For example, the mask data 133 could include a digital image mask indicating a location of one or more pixels that represent the mannequin depicted in the image 115. As an example, and not by way of limitation, the mask data 133 could include black-and-white pixel data, such that a mannequin image area is indicated by one or more pixels having a value of 1 and an additional area (e.g., an area that does not depict the mannequin) is indicated by one or more pixels having a value of 0.

In some cases, the mannequin identification module 130 generates a base image 135 based on one or more of the image 115 or the mask data 133. The base image 135, for instance, includes digital image data representing the apparel item depicted in the image 115. Additionally or alternatively, the base image 135 omits digital image data representing the mannequin depicted in the image 115. For example, the base image 135 could include image data modified from the image 115, the modified data including (or otherwise based on) portions of the image 115 depicting the apparel item, and omitting portions of the image 115 depicting the mannequin. Although the image modification system 120 is depicted as including the mannequin identification module 130, other implementations are possible. For example, an image modification system could receive, such as from an additional computing system configured to identify mannequin image content, one or more of mask data or a base image that omits image data representing a mannequin.

In some implementations, the feature-extraction module 140 identifies one or more image features of a received image. For example, the feature-extraction module 140 identifies image features of the base image 135. Additionally or alternatively, the feature-extraction module 140 identifies additional image features of the additional images 117. For example, the feature-extraction module 140 includes one or more neural networks configured to extract image features from a digital image. In some cases, the feature-extraction module 140 generates image feature data 145. The image feature data 145 describes, for example, image features of one or more of the images 135 or 117. In some cases, the feature-extraction module 140 identifies image features of the image 115, or the image feature data 145 could include image features of the image 115. Although the image modification system 120 is depicted as including the feature-extraction module 140, other implementations are possible. For example, an image modification system could receive, such as from an additional computing system configured to extract image features of digital images, image feature data for one or more of an image depicting an apparel item displayed by a mannequin, a base image depicting the apparel item and omitting content depicting a mannequin, or additional images depicting additional content for the apparel item.

In the image modification system 120, the feature-mapping module 150 determines one or more matching relationships between one or more pairs of image features. Additionally or alternatively, the feature-mapping module 150 generates feature matching data 155 describing the matching relationships. In some cases, the feature matching data 155 describes matching relationships between pairs of image features that include a particular image feature of the base image 135 and a particular additional feature of one of the additional images 117. In some cases, the feature matching data 155 includes data indicating one or more of a distance between image features, a ratio of distances between image features, a symmetry between at least two pairs of image features, a homography transformation matrix among multiple image features, or other suitable data describing matching relationships between at least two pairs of image features.

In FIG. 1, the image generation module 160 generates a modified base image 165. In some cases, the modified base image 165 is generated based on one or more of the base image 135, the additional images 117, or the feature matching data 155. For example, the image generation module 160 identifies, in the base image 135, one or more pixels that are associated with a mannequin image area. The pixel associated with the mannequin image area is located, for example, in an area that corresponds to a mannequin depicted in the image 115. In some cases, the image generation module 160 identifies the pixel associated with the mannequin image area via, for example, the mask data 133.

Additionally or alternatively, the image generation module 160 determines that the pixel associated with the mannequin image area (e.g., a mannequin pixel) corresponds to an additional pixel that is included in an additional image of the additional images 117. As a non-limiting example, the additional pixel could depict a portion of the apparel item (e.g., depicted in the images 115 or 135) that is occluded by the mannequin (e.g. depicted in the image 115). In some cases, the association between the mannequin pixel and the additional pixel is determined based on a matching relationship between the pixels, such as a matching relationship described by the feature matching data 155. In FIG. 1, the image generation module 160 identifies image data of the additional pixel, such as image data depicting the occluded portion of the apparel item. Additionally or alternatively, the image generation module 160 modifies the pixel to include the image data of the additional pixel. For example, the image generation module 160 creates the modified base image 165 that includes the pixel (e.g., from the base image 135) modified to include the image data of the additional pixel (e.g., from the additional images 117).

In some cases, the modified base image 165 includes a ghost mannequin effect applied to image content, such as the image content of the base image 135. In the modified base image 165, the ghost mannequin effect includes, for example, modified image data that depicts the apparel item (e.g., as depicted in the base image 135) in combination with additional image data (e.g., as depicted in one or more of the additional images 117) depicting occluded areas of the apparel item (e.g., areas occluded by the mannequin in the image 115). The ghost mannequin effect depicts, for instance, the apparel item with a realistic shape or form of being worn and also depicts portions of the apparel item that would be occluded by a mannequin.

In some implementations, the image modification system 120 provides the modified base image 165 to one or more additional computing systems. For example, the modified base image 165 is provided to one or more of the user device 110 or the image repository 102. In some cases, the user device 110 is configured to display the modified base image 165 via the user interface 105. Additionally or alternatively, the image modification system 120 provides the modified base image 165 to one or more computing devices of the online distribution environment. For example, a data repository of the online distribution environment (such as, without limitation, the image repository 102) could receive the modified base image 165. Additionally or alternatively, the online distribution environment provides the modified base image 165, such as in response to search queries (or other inputs) indicating the apparel item depicted in the images 115, 117, or 165.

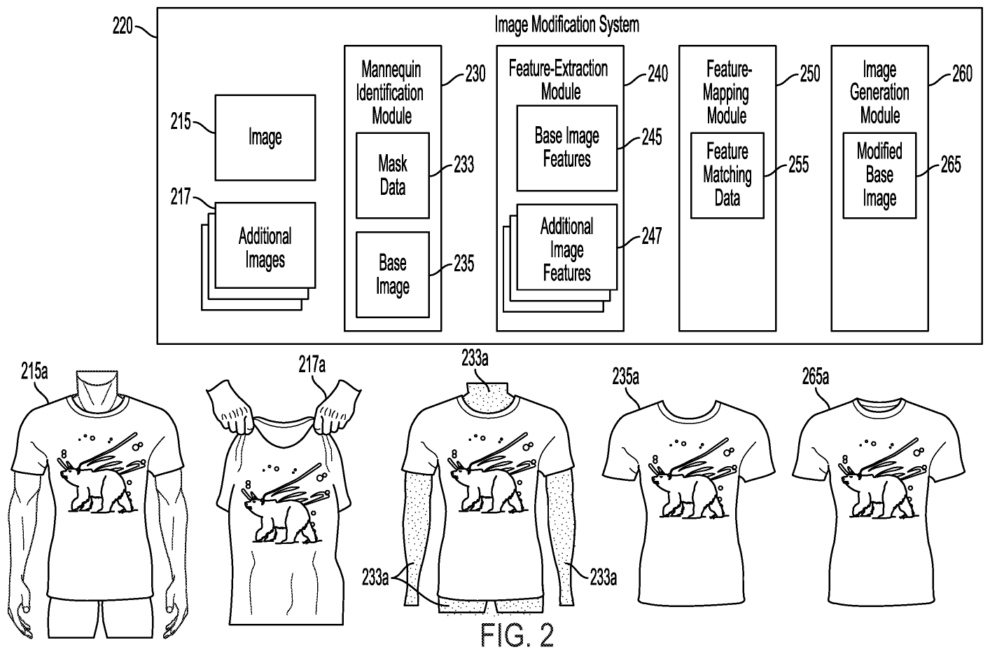

In some implementations, an image modification system is configured to apply a ghost mannequin effect to image data depicting an apparel item in a base image. For example, the image modification system generates a modified base image that depicts the apparel item with the applied ghost mannequin effect. FIG. 2 depicts an example of an image modification system 220 that is configured to generate a modified base image 265 based on an image 215 and one or more additional images 217. In some cases, one or more of the image 215 or the additional images 217 are received from an additional computing system, such as one or more of an online distribution environment or a user computing device (e.g., the user computing device 110). In some cases, the image modification system 220 is included in (or otherwise capable of communicating with) an online distribution environment, such as described in regards to FIG. 1.

In some implementations, one or more of the image 215 or the additional images 217 depict at least one apparel item, such as an apparel item available for distribution via the online distribution environment. In some cases, the image 215 depicts the at least one apparel item displayed on a mannequin. As a non-limiting example, an example image 215a depicts an apparel item, such as a T-shirt, that is worn by a mannequin, such as a plastic clothing mannequin. Additionally or alternatively, each of the additional images 217 depicts additional image content describing the at least one apparel item. As a non-limiting example, an example additional image 217a depicts an additional view of the apparel item from the image 215a (e.g., held up for display by a person), such as an additional view that includes image content of a back collar of the T-shirt.

In some implementations, the image modification system 220 includes one or more of a mannequin identification module 230, a feature-extraction module 240, a feature-mapping module 250, or an image generation module 260. In FIG. 2, the mannequin identification module 230 identifies one or more areas of the image 215 that depict the mannequin. In some cases, the mannequin identification module 230 generates mask data 233 that indicates locations of one or more pixels representing the mannequin depicted in the image 215. As a non-limiting example, the mask data 233 could include data describing example mask areas 233a, such as mask data indicating pixels depicting the neck, arms, and legs of the example plastic clothing mannequin. Additionally or alternatively, the mannequin identification module 230 generates a base image 235 based on one or more of the image 215 or the mask data 233. For instance, the base image 235 includes digital image data representing the apparel item depicted in the image 215 and omits digital image data representing the mannequin depicted in the image 215. As a non-limiting example, an example base image 235a depicts the T-shirt from the image 215a and omits the plastic clothing mannequin from the image 215a. The base image 235a omits mannequin image areas indicated by, for instance, the example mask areas 233a. In some cases, the base image 235 includes modified image data for one or more pixels that are identified as being included in a mannequin image area, such as by modifying pixels to include a background color, an indicator color, null data (e.g., data indicating no image information), or other suitable data. For instance, the base image 235a includes image data describing a background color (e.g., white, null data) for pixels identified as being included in the example mask areas 233a. In various embodiments, the mannequin identification module 230 can be implemented as one or more of program code, program code executed by processing hardware (e.g., a programmable logic array, a field-programmable gate array), firmware, or some combination thereof.

In some implementations, the feature-extraction module 240 identifies image features of one or more of the base image 235, the additional images 217, or the image 215. For example, the feature-extraction module 240 generates base image features 245 that are extracted from the base image 235. Additionally or alternatively, the feature-extraction module 240 generates additional image features 247 that are extracted from the additional images 217. In some cases, the additional image features 247 include multiple sets of image features, each particular set of image features corresponding to a particular one of the additional images 217. As a non-limiting example, the base image features 245 could include data describing image features of the example base image 235a, such as edges, colors, gradients, or other suitable features that describe image characteristics of the base image 235a. Additionally or alternatively, the additional image features 247 could include data describing image features of the example additional image 217a, such as features that describe image characteristics of the additional image 217a. In some cases, the base image features 245 or additional image features 247 could describe image characteristics that are (without limitation) visible to a human viewer, such as features based on a pattern or fabric arrangement of the example T-shirt in the example images 235a or 217a. In some cases, the image features 245 or 247 could describe image characteristics that are not visible (or not readily visible) to a human viewer, such as features based on mathematical representations of a color gradient or a regularity of a pattern.

In some cases, the feature-extraction module 240 includes one or more neural networks that are configured to identify image features. As a non-limiting example, the feature-extraction module 240 could include one or more of a convolutional neural network, a region-based convolutional neural network, a deep neural network, a deep learning neural network, or any other suitable type of neural network that is configurable to identify image features. Additionally or alternatively, the feature-extraction module 240 could be configured (or include one or more neural networks configured) to identify image features based on one or more feature-identification techniques, such as (without limitation) a features from accelerated segments test (“FAST”) technique, a binary robust independent elementary features (“BRIEF”) technique, an oriented FAST and rotated BRIEF (“ORB”) technique, a scale-invariant feature transform (“SIFT”) technique, or any other suitable technique or combination of techniques for identifying image features. In various embodiments, the feature-extraction module 240 can be implemented as one or more of program code, program code executed by processing hardware (e.g., a programmable logic array, a field-programmable gate array), firmware, or some combination thereof.

In the image modification system 220, the feature-mapping module 250 determines one or more matching relationships between or among multiple image features. Additionally or alternatively, the feature-mapping module 250 generates feature matching data 255 describing the matching relationships. In some cases, the feature matching data 255 describes matching relationships between pairs of image features that include a particular image feature of the base image 235 and a particular additional feature of one of the additional images 217. For example, the feature-mapping module 250 is configured (or includes one or more neural networks configured) to perform a matching technique that identifies matching features between multiple sets of image features. In FIG. 2, the feature-mapping module 250 is configured to identify one or more pairs of matching features between the base image features 245 and one or more sets of the additional image features 247. As a non-limiting example, the feature-mapping module 250 could determine matching features between the example base image 235a and the example additional image 217a. In some cases, the feature-mapping module 250 is configured to perform one or more feature-mapping techniques, such as, without limitation, a K-nearest neighbor matching technique, a ratio test, a blockwise homography matching technique, or any other suitable technique or combination of techniques for mapping image features among multiple sets of image features. In some cases, the feature-mapping module 250 is configured to perform one or more feature-mapping verification techniques, such as, without limitation, a multidirectional K-nearest neighbor matching verification technique, a symmetry verification technique, a blockwise homography verification technique, a random sample consensus (“RANSAC”) verification technique, or any other suitable technique or combination of techniques for verifying an accuracy of a set of matched image features. In various embodiments, the feature-mapping module 250 can be implanted as one or more of program code, program code executed by processing hardware (e.g., a programmable logic array, a field-programmable gate array), firmware, or some combination thereof.

In some implementations, the image generation module 260 generates a modified base image 265 using one or more of the base image 235, the additional images 217, or the feature matching data 255. In some cases, the image generation module 260 generates the modified base image 265 by combining image data from the base image 235 and image data from at least one of the additional images 217. Additionally or alternatively, the image generation module 260 generates occlusion image data that includes at least a portion of the combined image data. For example, the image generation module 260 identifies, based on the mask data 233, one or more pixels in the base image 235 that are associated with a mannequin image area, such as by identifying in the mask data 233 locations of pixels in a mannequin image area.

Additionally or alternatively, the image generation module 260 identifies one or more additional pixels in at least one of the additional images 217 that correspond to the mannequin pixels of the base image 235. In some cases, the image generation module 260 identifies the correspondence between the mannequin pixels and the additional pixels based on the feature matching data 255. For example, using location data for a pair of matching features from the feature matching data 255, the image generation module 260 identifies a mannequin pixel that is located in an image area (e.g., a pixel block, an image sub-region localized around the mannequin pixel) that includes a matched feature from the base image features 245. Using the location data of the matching features, the image generation module 260 identifies an additional pixel that is located in an additional image area that includes a matched feature from the additional image features 247. Additionally or alternatively, the image generation module 260 modifies image data of the corresponding mannequin pixel to include image data from the additional pixel, such that the modified base image 265 depicts the corresponding mannequin pixel with the modified image data from the additional pixel. In some cases, the modified base image 265 includes the occlusion image data generated by the image generation module 260.

As a non-limiting example, an example modified base image 265a is generated by combining image data from the example base image 235a and the example additional image 217a. The combined image data depicts, for instance, a ghost mannequin effect applied to the base image 235a. In this example, the image generation module 260 identifies one or more mannequin pixels in the base image 235a as being associated with a mannequin image area depicting the plastic clothing mannequin, using location data of pixels included in the example mask areas 233a. For instance, the base image 235a includes one or more mannequin pixels in a neck area of the mask areas 233a. Additionally or alternatively, the image generation module 260 identifies one or more additional pixels in the additional image 217a as corresponding to the mannequin pixels from the base image 235a. For instance, the additional image 217a includes one or more additional pixels corresponding to the mannequin pixels in the collar area of the T-shirt. The correspondence is determined using location data for image features that have a matching relationship, such as a set of base image features and a set of additional image features identified in the feature matching data 255. For example, the image generation module 260 determines a location (e.g., within the base image 235a) of the mannequin pixel with respect to a location of one or more pixels depicting a particular feature of the base image 235a. Additionally or alternatively, the image generation module 260 determines a location (e.g., within the additional image 217a) of the corresponding pixel with respect to a location of one or more pixels depicting the matching particular feature of the additional image 217a. In some cases, the correspondence of the pixel and the additional pixel is determined, at least in part, using a homography transformation matrix that indicates a location relationship between matching features. For example, if the homography transformation matrix indicates that the particular feature of the additional image 217a has a translated location as compared to the particular feature of the base image 235a, such as a translation resulting from a change between images 235a and 217a (e.g., changed image perspective, changed position of the apparel item), the corresponding pixel is identified by applying the translation to the location of the mannequin pixel.

The image generation module 260 generates the modified base image 265a, for example, by modifying the mannequin pixel in the collar area of the T-shirt to include image data of the additional pixel from the additional image 217a. The modified base image 265a depicts an example of a ghost mannequin effect applied to image content, such as the T-shirt of the base image 235a. The ghost mannequin effect includes, for example, a dimensional appearance of the apparel item, such as a fabric arrangement showing folds or curves that would fit over a form of a mannequin or a person wearing the T-shirt. Additionally or alternatively, the ghost mannequin effect includes occluded areas of the apparel item, such as image data depicting fabric from the collar area of the T-shirt that is occluded by the plastic clothing mannequin from the example image 215a. In various embodiments, the image generation model 260 can be implemented as one or more of program code, program code executed by processing hardware (e.g., a programmable logic array, a field-programmable gate array), firmware, or some combination thereof.

In some implementations, the image modification system 220 provides the modified base image 265 to one or more additional computing systems. In some cases, the modified base image 265 is provided to a computing system that is configured to display the modified base image 265 via one or more display devices, such as a display device in communication with the user interface 105 of the user computing device 110. Additionally or alternatively, the image modification system 220 provides the modified base image 265 to one or more computing devices of an online distribution environment. For example, the modified base image 265 is provided to a data repository (such as, without limitation, the image repository 102) of the online distribution environment, such that the modified base image 265 is accessible in response to search queries (or other inputs) indicating the apparel item depicted in the images 215, 217, or 265.

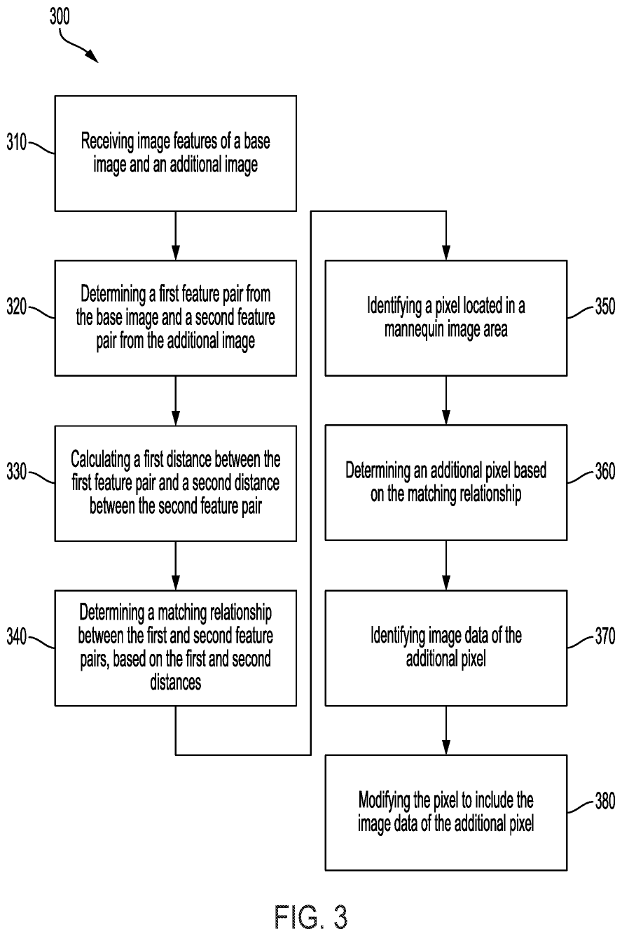

FIG. 3 is a flowchart depicting an example of a process 300 for applying a ghost mannequin effect to image data depicting an apparel item. In some embodiments, such as described in regards to FIGS. 1-2, a computing device executing an image modification system implements operations described in FIG. 3, by executing suitable program code. For illustrative purposes, the process 300 is described with reference to the examples depicted in FIGS. 1-2. Other implementations, however, are possible. In some embodiments, one or more operations described herein with respect to the process 300 can be used to implement one or more steps for performing a ghost mannequin effect application technique.

At block 310, the process 300 involves receiving image features of a base image and an additional image, such as base image features corresponding to the base image and additional image features corresponding to the additional image. Each of the base image and the additional image depicts, for example, a particular apparel item. Additionally or alternatively, the base image depicts the particular apparel item displayed on a mannequin. In some cases, the additional image features are included in a group of multiple sets of additional image features, each one of the sets corresponding to a particular additional image. In some implementations, a feature-mapping module of an image modification system receives the base image features describing the base image and one or more sets of additional image features, respectively describing one or more additional images. For example, the feature-mapping module 250 receives the base image features 245 and the additional image features 247, respectively corresponding to the base image 235 and the additional images 217. In some cases, one or more of the base image features or the additional image features are generated by a feature-extraction module of the image modification system. Additionally or alternatively, one or more of the base image features or the additional image features are received from an additional computing system that is configured to identify image features of digital images. For example, the feature-mapping module 250 receives one or more of the base image features 245 or the additional image features 247 from the feature-extraction module 240.

At block 320, the process 300 involves determining a first pair of image features of the base image. Additionally or alternatively, the process 300 involves determining a second pair of image features of the additional image. In some cases, the feature-mapping module determines the first feature pair based on the image features of the base image and the second feature pair based on the additional image features of the additional image. For example, the feature-mapping module 250 identifies a first set of image features from the base image features 245 and a second set of image features from a particular set of the additional image features 247. The first feature set describes, for example, two or more image features of the base image 235. The second feature set describes, for example, two or more additional image features of a particular one of the additional images 217 (e.g., the example additional image 217a). In some implementations, the feature-mapping module generates feature matching data indicating one or more of the first feature pair or the second feature pair. For example, the feature matching data 255 indicates the first feature set and the second feature set.

In some implementations, the first feature pair and the second feature pair are determined based on one or more feature-mapping techniques, such as, without limitation, a K-nearest neighbor matching technique. For example, the feature-mapping module 250 applies a K-nearest neighbor matching technique applied to the base image features 245 and one or more sets of the additional image features 247. Additionally or alternatively, based on the K-nearest neighbor matching technique, the feature-mapping module 250 identifies one or more of the base image features 245 for inclusion in the first feature set and one or more of the additional image features 247 for inclusion in the second feature set.

At block 330, the process 300 involves calculating, such as by the feature-mapping module, a first distance between the first feature pair and a second distance between the second feature pair. In some cases, the feature-mapping module generates (or modifies) the feature matching data to indicate one or more of the first distance or the second distance. The feature-mapping module 250, for example, calculates a first distance between two or more features of the example base image 235 and a second distance between two or more features of a particular one of the additional images 217 (e.g., the example additional image 217a). Additionally or alternatively, the feature-mapping module 250 modifies (or generates) the feature matching data 255 to indicate the first distance and the second distance. The first distance and the second distance are based on, for example, one or more pixel distances within the base image or the additional image. For example, the first distance indicates a distance between pixels in the base image that depict the first pair of image features (e.g., pixels depicting the base image features 245), and the second distance indicates a distance between pixels in the additional image that depicts the second pair of image features (e.g., pixels depicting the additional image features 247).

At block 340, the process 300 involves determining a matching relationship between the first feature pair and the second feature pair. In some cases, the feature-mapping module determines the relationship based on the first distance and the second distance. For example, the feature-mapping module 250 determines a matching relationship between the first feature set for the base image 235 and the second feature set for the particular one of the additional images 270. In some cases, the feature-mapping module generates (or modifies) the feature matching data to indicate the matching relationship. For example, the feature-mapping module 250 modifies (or generates) the feature matching data 255 to indicate the matching relationship between the first feature set and the second feature set. In some cases, one or more operations described with respect to block 340 can be used to implement a step for generating occlusion image data from corresponding image data that is identified based on a matching relationship between a first pair of the image features and a second pair of the additional image features.

In some implementations, the matching relationship is determined via one or more feature-mapping techniques, such as (without limitation) a ratio test or a blockwise homography matching technique. For example, the feature-mapping module 250 determines a ratio between a combination of distances including the first distance and the second distance. Additionally or alternatively, the feature-mapping module 250 determines the matching relationship between the first feature set and the second feature set based on the ratio. For example, the feature-mapping module 250 compares the ratio to a feature similarity threshold. Responsive to determining that the ratio exceeds (or otherwise fulfills) the feature similarity threshold, the feature-mapping module 250 determines that a matching relationship exists between the first feature set and the second feature.

In some cases, one or more matching relationships are verified based on one or more feature-mapping verification techniques, such as, without limitation, a multidirectional K-nearest neighbor verification technique, a symmetry verification technique, or a blockwise homography verification technique. For example, the feature-mapping module 250 verifies the image features in the first feature set and the second feature set by applying a multidirectional K-nearest neighbor verification technique to the base image features 245 and each set of the additional image features 247. Additionally or alternatively, the feature-mapping module 250 verifies the ratio of the combination of distances by applying one or more of a symmetry verification technique or a blockwise homography verification technique.

In some implementations, operations related to one or more of blocks 310, 320, 330, or 340 are repeated. For example, the feature-extraction module 240 could extract a set of the additional image features 247 for each image of the additional images 217. Additionally or alternatively, the feature-mapping module 250 could determine multiple feature sets from the base image features 245 or one or more of the sets of additional image features 247, or calculate multiple respective distances between (or among) the multiple feature sets. Furthermore, the feature-mapping module 250 could determine multiple matching relationships between (or among) multiple feature sets, such as multiple matching relationships between multiple feature sets from the base image features 245 and multiple feature sets from a particular set of the additional image features 247, or between multiple feature sets from the base image features 245 and multiple feature sets from multiple sets of the additional image features 247.

At block 350, the process 300 involves identifying a pixel that is located in a mannequin image area, such as one or more mannequin pixels of the base image. In some cases, an image generation module of the image modification system identifies the mannequin pixel based on mask data indicating image areas depicting a mannequin. For example, the image generation module 260 identifies one or more mannequin pixels of the base image 235 based on the mask data 233. The identified mannequin pixels are, for instance, associated with areas of the example image 215a that depict the example plastic clothing mannequin.

At block 360, the process 300 involves determining that the pixel corresponds to an additional pixel that is included in the additional image. Additionally or alternatively, the correspondence between the pixel and the additional pixel is determined based on the matching relationship. For example, using location data of a set of features having a matching relationship, such as the first feature pair and the second feature pair, the image generation module identifies an additional pixel that corresponds to the mannequin pixel. In some cases, the mannequin pixel is within an image area of the first feature pair (e.g., within the base image) and the additional pixel is within an image area of the second feature pair (e.g., within the additional image). For example, the image generation module 260 identifies that a mannequin pixel from the base image 235 corresponds to an additional pixel from a particular one of the additional images 217. Additionally or alternatively, the image generation module 260 identifies the correspondence of the pixels using location data of the first feature set and the second feature set having the matching relationship, such as the matching relationship described in the feature matching data 255. For example, using location data for the first feature set in the base image 235, the image generation module 260 identifies a mannequin pixel that is located in an image area that includes the first feature set. Using the location data of the matching features, e.g., the second feature set, the image generation module 260 identifies an additional pixel that is located in an additional image area that includes the second feature set. In some cases, one or more operations described with respect to block 360 can be used to implement a step for generating occlusion image data from corresponding image data that is identified based on a matching relationship between a first pair of image features and a second pair of additional image features.

At block 370, the process 300 involves identifying image data of the additional pixel. In some implementations, the image generation module identifies the image data from the additional image in which the additional pixel is included. For example, the image generation module 260 identifies image data for the additional pixel from the example additional image 217a. The image data depicts, for example, a portion of the apparel item that is occluded in the mannequin pixel, such as occlusion by a mannequin on which the apparel item is displayed.

At block 380, the process 300 involves modifying the pixel to include the image data of the additional pixel. In some cases, the base image in which the pixel is included is modified, such as to include a ghost mannequin effect. For example, the image generation module modifies the base image (e.g., generates a modified base image) to include, at the location of the mannequin pixel, the identified image data from the additional pixel. Additionally or alternatively, the modified base image depicts a ghost mannequin effect applied to image content of the base image, such as a ghost mannequin effect applied to an apparel item depicted in the base image. For example, the image generation module 260 generates the modified base image 265 by combining image data from the base image 235 and image data from a particular one of the additional images 217. The modified base image 265 depicts image content with an applied ghost mannequin effect, such as the ghost mannequin effect depicted in the example modified base image 265a. In some cases, the ghost mannequin effect includes a dimensional appearance of the apparel item combined with additional image data depicting occluded areas of the apparel item, such as the shape of the T-shirt from the example base image 235a combined with image data, from the example additional image 217a, depicting the collar area of the T-shirt. In some cases, one or more operations described with respect to block 380 can be used to implement a step for generating occlusion image data from corresponding image data that is identified based on a matching relationship between a first pair of the image features and a second pair of the additional image features. For example, the occlusion image data includes a combination of image data from a base image and an additional image, such as combined image data that indicates a pixel location of the mannequin pixel and image data of the corresponding additional pixel. In some cases, the combination of image data is determined based on a matching relationship between features of the base image and additional features of the additional image, such as by identifying a location of the mannequin pixel with respect to the first pair of the image features and an additional location of the corresponding additional pixel with respect to the second pair of the image features. Additionally or alternatively, the correspondence of the pixel and the additional pixel is determined, at least in part, by using a homography transformation matrix that indicates a location relationship between matching features. For example, if the homography transformation matrix indicates that the second pair of features has a transformed (e.g., skewed, rotated, laterally translated) location as compared to the first pair of features, the corresponding pixel is identified by applying the translation to the location of the mannequin pixel.

In some implementations, operations related to one or more of blocks 350, 360, 370, or 380 are repeated. For example, the image generation module 260 could identify multiple mannequin pixels in the base image 235. Additionally or alternatively, the image generation module 260 could determine multiple additional pixels corresponding to the multiple mannequin pixels, or identify respective image data for the multiple additional pixels. Furthermore, the image generation module 260 could modify multiple pixels of the base image 235. For example, the modified base image 265 could include multiple modified pixels corresponding to some, all, or none of occluded areas (e.g., mannequin pixels) in the base image 235 or the image 215.

In some implementations, a modified base image (or other modified image data) generated via one or more operations in the process 300 is provided for display. For example, the image modification system described in regards to the process 300 can configure a display device to present digital image content that includes the modified base image or additional modified image content, such as the mannequin pixel modified to include the image data from the additional pixel. In some cases, the image modification system described in regards to the process 300 provides the modified base image or additional modified image content to one or more additional computing systems, such as one or more of an online distribution environment or a user device (such as described in regards to FIG. 1).

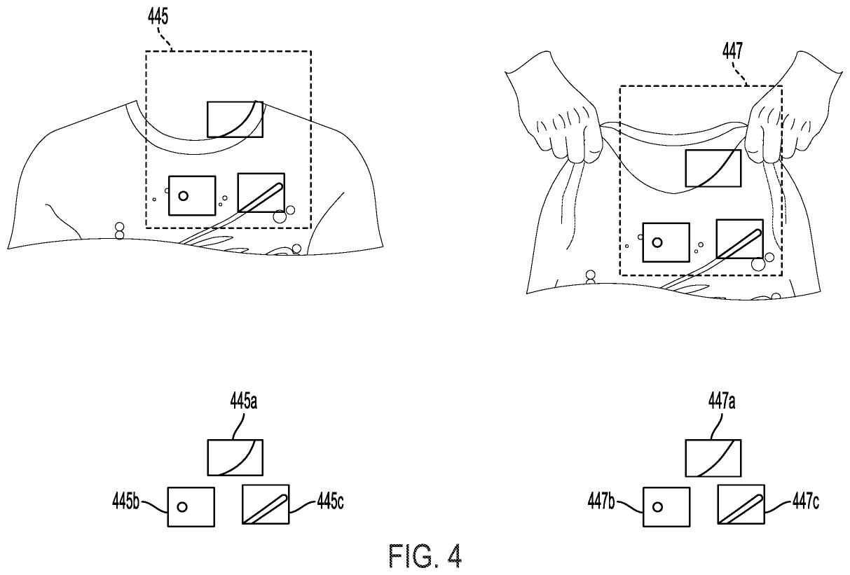

In some implementations, an image modification system is configured to determine one or more matching relationships of image features of multiple images. For example, a feature-mapping module determines one or more matching relationships between (or among) a set of features from a base image and a set of features from an additional image. FIG. 4 depicts an example of image features by which an image modification system can determine one or more matching relationships among the image features. Additionally or alternatively, the example image modification system is configured to determine the one or more matching relationships by applying one or more feature-mapping techniques to the example image features depicted in FIG. 4. For example, and not by way of limitation, the feature-mapping module 250 could use one or more of the feature-mapping techniques or image features described in regards to FIG. 4 to generate (or modify) the feature matching data 255.

In FIG. 4, a set of image features 445 are extracted from a digital image, such as a base image depicting an apparel item. In some cases, the feature-extraction module 240 extracts the sets of features 445 and 447 from, respectively, the base image 235 and the additional images 217. For example, the set of image features 445 are included in the base image features 245, and are extracted from the base image 235. The set of image features 445 includes multiple image features of the example base image 235a, such as a feature 445a indicating an arrangement of fabric (e.g., an arrangement of the T-shirt collar), a feature 445b indicating a pattern (e.g., a curved pattern of the T-shirt print), or a feature 445c indicating an additional pattern (e.g., a lateral pattern of the T-shirt print). Additionally or alternatively, the set of image features 447 are included in a particular set of the additional image features 247, and are extracted from a particular one of the additional images 217 that corresponds to the particular set of the additional image features 247. The set of image features 447 includes multiple image features of the example additional image 217a, such as a feature 447a indicating an arrangement of fabric, a feature 447b indicating a pattern, or a feature 447c indicating an additional pattern. For convenience, and not by way of limitation, the sets of features 445 and 447 depict features that are visible to a human viewer (e.g., a person observing the example images 235a or 217a), but other implementations are possible, including extraction of or determining matching relationships among features that are not perceptible by a human viewer.

In some implementations, the example feature-mapping module applies one or more feature-mapping techniques to one or more of the sets of features 445 or 447. In some cases, the feature-mapping module performs a K-nearest neighbor matching technique between a set of base image features and one or more sets of additional image features. For example, the feature-mapping module identifies a group of potential matching image features, such as a group of features that are within a similarity threshold of the K-nearest neighbor matching technique. Additionally or alternatively, the feature-mapping module applies a ratio test to the group of potential matching image features. For example, the feature-mapping module identifies (or verifies) one or more matching relationships between or among the group of potential matching image features by comparing distance ratios of features in the group. In some cases, the feature-mapping module generates (or modifies) feature matching data that indicates one or more of the identified matching relationships or the potential matching image features.

For instance, the feature-mapping module 250 performs a K-nearest neighbor matching technique between the base image features 245 and one or more sets of the additional image features 247. The K-nearest neighbor matching technique indicates one or more features of the base image features 245 that have a visual similarity to one or more features of the additional image features 247. In some cases, a classification neural network included in (or in communication with) the feature-mapping module 250 is applied to the feature sets 245 and 247 to determine the visual similarity. As an example, and not by way of limitation, the feature-mapping module 250 (or the classification neural network) identifies mathematical similarities between vector representations of the features 245 and 247, such as a Euclidian distance between features represented in a vector space. In some cases, the feature-mapping module 250 compares the visual similarities between image features to a feature similarity threshold. In some cases, the feature-mapping module 250 identifies a group of potential matching image features from the features 245 and 247, such as a group of features that exceed (or otherwise fulfill) the feature similarity threshold. Additionally or alternatively, the feature-mapping module 250 generates (or modifies) the feature matching data 255 to indicate the potential matching image features.

In some cases, the example K-nearest neighbor matching technique is applied to a subset of features from the base image features 245 and the additional image features 247. The feature-mapping module 250 identifies, for example, one or more blocks of pixels in the base image 235 that are associated with one or more image features, e.g., an image feature that is depicted by one or more pixels within a particular block. Additionally or alternatively, the feature-mapping module 250 identifies one or more blocks of pixels in the additional images 217 that are associated with one or more additional image features. In some cases, the feature-mapping module 250 selects a subset of pixel blocks, such as a subset including selected pixel blocks that have a threshold quantity of neighbor blocks (e.g., neighboring pixel blocks including one or more image features) that are within a threshold distance from the selected pixel blocks. Additionally or alternatively, the feature-mapping module 250 applies the example K-nearest neighbor matching technique to features included in the subsets of pixel blocks. For example, and not by way of limitation, the feature-mapping module 250 could select a subset of pixel blocks from the base image 235a and a subset of pixel blocks from the additional image 217a, such that each selected block included in the subsets has a quantity of two or more neighbor blocks that are within a distance of 100 pixels from the selected block. In this example, the feature-mapping module 250 could apply the example K-nearest neighbor matching technique to the features within each pixel block that meets the criteria for the subset of pixel blocks.

In some cases, a multidirectional K-nearest neighbor matching technique is applied to sets of image features. For example, the feature-mapping module 250 applies the example K-nearest neighbor matching technique to the base image features 245 with respect to the additional image features 247, and to the additional image features 247 with respect to the base image features 245. In some cases, applying a multidirectional K-nearest neighbor matching technique to multiple groups of features verifies a group of potential matching image features.

In some implementations, the feature-mapping module 250 identifies a group of potential matching image features by applying the example K-nearest neighbor matching technique to the features 245 and 247. In FIG. 4, the potential group of matching image features includes the set of image features 445 and the set of additional image features 447. For example, the feature-mapping module 250 identifies respective potential matches between the features 445a and 447a, the features 445b and 447b, and the features 445c and 447c, such as potential matches indicated by respective Euclidian distances between vector representations of the features in a vector space.

In some cases, the feature-mapping module 250 applies a ratio test to the group of potential matching image features. For example, the feature-mapping module 250 determines a ratio of two or more distances between, at least, a first pair of image features and a second pair of image features. As described in regards to FIG. 4, the ratio test is applied to one or more pixel distances (e.g., distances between pixels within an image) between pixels that depict the image feature pairs. However, other implementations are possible, such as a ratio test applied to a Euclidian distance between vector representations of the feature pairs within a vector space.

In FIG. 4, the feature-mapping module 250 determines a first distance between a first pair of the image features 445 and a second distance between a second pair of the additional image features 447. For instance, the first distance is determined between the features 445a and 445b, and the second distance is determined between the additional features 447a and 447b. Additionally or alternatively, the feature-mapping module 250 determines a third distance between a third pair of the image features 445 and a fourth distance between a fourth pair of the additional image features 447, such as a third distance between the features 445b and 445c, and a fourth distance between the additional features 447b and 447c. In some cases, the first, second, third, and fourth distances are determined between feature pairs that have potential matches. For example, the first and second distances include pairs of features with potential matches, such as the potential matches between the features 445a and 447a and the features 445b and 447b, and the third and fourth distances include further feature pairs that have potential matches, such as the potential matches between the features 445b and 447b, and the features 445c and 447c.

In some implementations, the feature-mapping module 250 applies the example ratio test to feature sets 445 and 447 based on the first, second, third, and fourth distances. The feature-mapping module 250 determines, for example, a first ratio of distances associated with the base image 235a, such as the first distance between features 445a and 445b and the third distance between features 445b and 445c. Additionally or alternatively, the feature-mapping module 250 determines a second ratio of distances associated with the additional image 217a, such as the second distance between features 447a and 447b and the fourth distance between features 447b and 447c. In some cases, each ratio test includes two or more distances that are based on a particular feature from the image feature set. In FIG. 4, for example, the first ratio of distances includes the first and third distances including the image feature 445b, and the second ratio of distances includes the second and fourth distances including the additional image feature 447b.

In some implementations, the feature-mapping module 250 determines a matching relationship between (or among) two or more pairs of features by comparing two or more distance ratios. Additionally or alternatively, the feature-mapping module 250 generates (or modifies) the feature matching data 255 to indicate one or more of the matching relationship, the distance ratios, or the distances between the feature pairs. For example, the feature-mapping module 250 compares the first ratio of distances and the second ratio of distances, such as by determining whether the first ratio is within a feature similarity threshold to the second ratio. Responsive to determining that the first and second ratios are within the feature similarity threshold, the feature-mapping module 250 identifies a matching relationship between the set of image features 445 and the set of additional image features 447. For example, the feature-mapping module 250 modifies the feature matching data 255 to include a first matching relationship between the features 445a and 447a, a second matching relationship between the features 445b and 447b, and a third matching relationship between the features 445c and 447c.

In some cases, a blockwise homography technique is applied to a set of image features with a matching relationship. For example, the feature-mapping module 250 identifies, such as from the feature matching data 255, one or more pixel blocks that include a threshold quantity (e.g., four features) of features having matching relationships (e.g., a pixel block having four features with matching relationships). For example, the feature-mapping module 250 identifies a pixel block from the base image 235a and a corresponding pixel block from the additional image 217a, such that the pixel block includes four image features that have matching relationships with four additional image features of the corresponding pixel block. Additionally or alternatively, the feature-mapping module 250 applies an example blockwise homography technique to the identified pixel blocks. In some cases, the feature matching data 255 is modified to include (or otherwise indicate) a homography transformation matrix indicating one or more homographic mappings of image features from the base image 235a and additional image features from base image 217a. In some cases, applying a blockwise homography technique to pixel blocks verifies a matching relationship between (or among) image features in pixel blocks from a base image and one or more additional images.

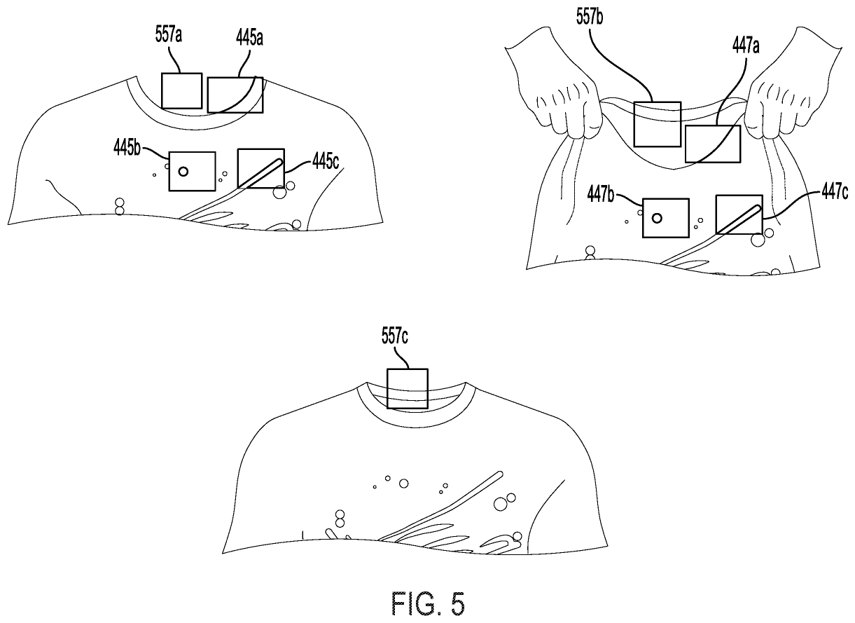

In some implementations, an image modification system is configured to identify one or more occluded pixels from a digital image. For example, an image generation module identifies one or more occluded pixels (e.g., mannequin pixels) in an image depicting at least one apparel item displayed on a mannequin. Additionally or alternatively, the image generation module modifies the occluded pixel to include image data of an additional pixel depicting the apparel item. FIG. 5 depicts an example of occluded pixels in a base image that are modified by an image modification system to include image data from additional pixels in an additional image. For example, and not by way of limitation, the image generation module 260 could use one of more of the pixel identification techniques or pixel modification techniques described in regards to FIG. 5 to generate the modified base image 265.

In FIG. 5, the image features 445a, 445b, and 445c are extracted from a base image depicting an apparel item, such as the base image 235a. Additionally or alternatively, the additional image features 447a, 447b, and 447c are extracted from an additional image including additional image content depicting the apparel item, such as the additional image 217a. In some cases, one or more matching relationships are determined among the features 445a, 445b, and 445c and the additional features 447a, 447b, and 447c. For example, the feature matching data 255 includes data indicating the first matching relationship between the features 445a and 447a, the second matching relationship between the features 445b and 447b, and the third matching relationship between the features 445c and 447c. Additionally or alternatively, the feature matching data 255 includes data describing the homography transformation matrix that indicates homographic mappings of image features from the base image 235a and additional image features from base image 217a.

In some implementations, the image generation module 260 determines one or more pixels that are occluded, such as pixels 557a included in the base image 235a. In some cases, the pixels 557a are one or more of mannequin pixels or occluded pixels, such as pixels indicated by the mask data 233. Additionally or alternatively, the image generation module 260 determines that the pixels 557a correspond to one or more additional pixels included in an additional image, such as pixels 557b included in the additional image 217a. For example, based on the matching relationships between the image features 445 and the additional image features 447 (e.g., as described in regards to FIG. 4), the image generation module 260 determines the correspondence between pixels 557a and 557b, such as by determining location data of the pixels 557a and 557b with respect to location data of pixels for the features 445 and 447. In some cases, the correspondence is determined, at least in part, by applying a location relationship indicated by the homography transformation matrix included in the feature matching data 255. For example, if the homography transformation matrix indicates a transformation (e.g., rotation, skewing, lateral translation) between the image features 445 and the additional image features 447, the image generation module 260 could apply the transformation to the occluded pixels 557a. Additionally or alternatively, the image generation module 260 identifies the corresponding pixels 557b by applying the transformation to the occluded pixels 557a. As a non-limiting example, if the apparel item has a different configuration (e.g., a different image view, a different arrangement of fabric) in the additional image 217a as compared to the base image 235a, the additional image features 447 could have locations in the additional image 217a that are changed from the matching image features 445 in the base image 235a. In this example, the homography transformation matrix could indicate a location relationship (e.g., a transformed location) of the additional pixels 557b as compared to the occluded pixels 557a.

In some cases, the image generation module 260 identifies image data of the additional pixels 557b, such as image data depicting a collar area of the T-shirt in the additional image 217a. Additionally or alternatively, the image generation module 260 modifies the pixels 557a to include the image data of the additional pixels 557b. In FIG. 5, the image generation module 260 generates one or more pixels 557c based on a combination of the pixels 557a and the additional pixels 557b. For example, the image generation module 260 generates (or modifies) the modified base image 265a to include the modified pixels 557c. The modified pixels 557c include a combination of image data from the pixels 557a and 557b, such as location data of the occluded pixels 557a within the modified image 265a and image content data of the additional pixels 557b. As a non-limiting example, the modified pixels 557c have locations within the mannequin (e.g., occluded) areas of the base image 235a, and image content depicting the T-shirt fabric occluded by the mannequin in the image 215a. In some cases, the modified pixels 557c depict a ghost mannequin effect in the modified base image 265a, such as a dimensional appearance of the T-shirt combined with image data depicting occluded areas of the T-shirt.

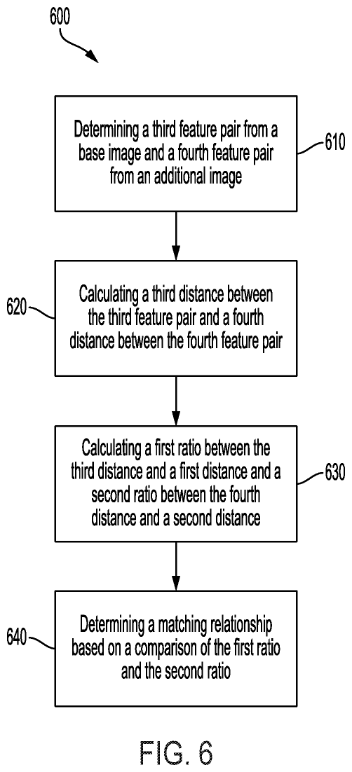

FIG. 6 is a flow chart depicting an example of a process 600 for applying a ratio test technique based on multiple image features. In some embodiments, such as described in regards to FIGS. 1-5, a computing device executing an image modification system implements operations described in FIG. 6, by executing suitable program code. For illustrative purposes, the process 600 is described with reference to the examples depicted in FIGS. 1-5. Other implementations, however, are possible. In some embodiments, one or more operations described herein with respect to the process 600 can be used to implement one or more steps for calculating one or more ratios involved in a ratio test technique.

In some implementations, one or more operations of the process 600 are performed by one or more components of an image modification system, such as the image modification system 220. Additionally or alternatively, one or more operations of the process 600 are performed in combination with one or more operations of the process 300. For example, a feature-mapping module implementing the process 600 receives a first pair of image features of a base image and a second pair of image features of an additional image, such as described in regards to, at least, block 320. Additionally or alternatively, the example feature-mapping module implementing the process 600 calculates a first distance between the first feature pair and a second distance between the second feature pair, such as described in regards to, at least, block 330. Furthermore, the example feature-mapping module implementing the process 600 determines a matching relationship between feature pairs, such as described in regards to, at least, block 340, based on data output by one or more operations of the process 600, such as, at least, block 640.

At block 610, the process 600 involves determining a third feature pair from a base image and a fourth feature pair from an additional image, such as the base image and the additional image described in regards to block 320. In some cases, the feature-mapping module determines the third feature pair based on the image features of the base image and the fourth feature pair based on the additional image features of the additional image. For example, the feature-mapping module 250 identifies the first set of image features and a third set of image features from the base image features 245. Additionally or alternatively, the feature-mapping module identifies the second set of additional image features and a fourth set of additional image features from a particular set of the additional image features 247 (e.g., as described in regards to block 320). In some cases, the first and third feature pairs include a particular image feature, and the second and fourth additional feature pairs include a particular additional image feature. For example, the feature-mapping module 250 identifies, from the base image features 245, the first set of image features 445a and 445b and the third set of image features 445b and 445c. Each of the first and third sets of image features includes, for example, the particular image feature 445b. Additionally or alternatively, the feature-mapping module 250 identifies, from a particular set of the additional image features 247, the second set of additional image features 447a and 447b and the fourth set of additional image features 447b and 447c. Each of the second and fourth sets of additional image features includes, for example, the particular additional image feature 447b.

In some implementations, the third feature pair and the fourth feature pair are determined based on one or more feature-mapping techniques, such as, without limitation, a K-nearest neighbor matching technique. Additionally or alternatively, the feature-mapping module generates feature matching data indicating one or more of the third feature pair or the fourth feature pair. For example, the feature matching data 255 indicates the third feature set and the fourth feature set.

At block 620, the process 600 involves calculating, such as by the feature-mapping module, a third distance between the third feature pair and a fourth distance between the fourth feature pair. The third distance and the fourth distance are based on, for example, one or more pixel distances within the base image or the additional image. For example, the third distance indicates a distance between pixels in the base image that depict the third pair of image features (e.g., pixels depicting the image features 445b and 445c), and the fourth distance indicates a distance between pixels in the additional image that depicts the fourth pair of image features (e.g., pixels depicting the additional image features 447b and 447c). In some cases, the feature-mapping module generates (or modifies) the feature matching data to indicate one or more of the third distance or the fourth distance. In some implementations, each of the first distance and the third distance are calculated based on the particular image feature. Additionally or alternatively, each of the second distance and the fourth distance are calculated based on the particular additional image feature. For example, the feature-mapping module 250 calculates the first distance between the first set of image features 445a and 445b and the third distance between the third set of image features 445b and 445c, such that each of the first distance and the third distance is based on a location of the particular image feature 445b. Additionally or alternatively, the feature-mapping module 250 calculates the second distance between the second set of additional image features 447a and 447b and the fourth distance between the fourth set of additional image features 447b and 447c, such that each of the second distance and the fourth distance is based on the location of the particular additional image feature 447b. In some cases, the feature matching data indicates one or more of the third distance or the fourth distance. For example, the feature-mapping module 250 modifies (or generates) the feature matching data 255 to indicate one or more of the first, second, third, or fourth distances.

At block 630, the process 600 involves calculating, such as by the feature-mapping module, a first ratio between the first distance and the third distance and a second ratio between the second distance and the fourth distance. For example, the feature-mapping module 250 applies a ratio test to the set of image features 445 and the set of additional image features 447. For example, the feature-mapping module 250 determines a first distance ratio of the first distance between features 445a and 445b and the third distance between features 445b and 445c. Additionally or alternatively, the feature-mapping module 250 determines a second distance ratio of the second distance between features 447a and 447b and the fourth distance between features 447b and 447c. In some cases, the feature matching data indicates one or more of the first ratio or the second ratio. For example, the feature-mapping module 250 modifies (or generates) the feature matching data 255 to indicate one or more of the first distance ratio or the second distance ratio. In some cases, one or more operations described with respect to block 630 can be used to implement a step for applying a ratio test technique to multiple image features, such as image features from one or more of a base image, a selected image area, or an additional image.

At block 640, the process 600 involves determining one or more matching relationships, such as a matching relationship based on a comparison of the first ratio and the second ratio. For instance, the matching relationship is identified as existing between or among two or more of the first, second, third, or fourth pairs of image features. In some cases, the feature-mapping module determines one or more matching relationships of the image features by comparing ratios that include one or more of the first, second, third, or fourth distances. For example, the matching relationships are determined by comparing the first ratio and the second ratio. For example, the feature-mapping module 250 determines whether the first distance ratio and the second distance ratio are within a feature similarity threshold. The feature similarity threshold indicates, for example, one or more of a percentage similarity (e.g., a value of the first distance ratio is within 10% of a value of the second distance ratio), a numeric similarity (e.g., a value of the first distance ratio is less than or equal to a value of the second distance ratio), or any other suitable comparison technique to identify similarity. Responsive to determining that the first ratio and the second ratio exceed (or otherwise fulfill) the feature similarity threshold, the feature-mapping module 250 identifies a matching relationship among two or more image features from the feature sets 445 and 447. For example, the feature-mapping module 250 identifies a first matching relationship between the features 445a and 447a, a second matching relationship between the features 445b and 447b, and a third matching relationship between the features 445c and 447c. In some cases, the feature matching data indicates one or more of the identified matching relationships. For example, the feature-mapping module 250 modifies (or generates) the feature matching data 255 to indicate one or more of the distance ratio or the second distance ratio. In some cases, one or more operations described with respect to block 640 can be used to implement a step for determining a matching relationship between or among multiple image features, such as image features from one or more of a base image, a selected image area, or an additional image.

In some cases, one or more operations described with respect to one or more of block 630 or block 640 can be used to implement a step for generating occlusion image data from corresponding image data that is identified based on a matching relationship between a first pair of the image features and a second pair of the additional image features.

In some implementations, operations related to one or more of blocks 610, 620, 630, or 640 are repeated. For example, the feature-extraction module 240 could calculate multiple distances or ratios between (or among) multiple features in multiple feature sets, such as comparing distance ratios associated with the base image features 245 to distance ratios associated with, respectively, each of the sets of additional image features 247. Additionally or alternatively, the feature-mapping module 250 could determine multiple matching relationships between (or among) multiple feature sets based on the multiple comparisons of distance ratios.

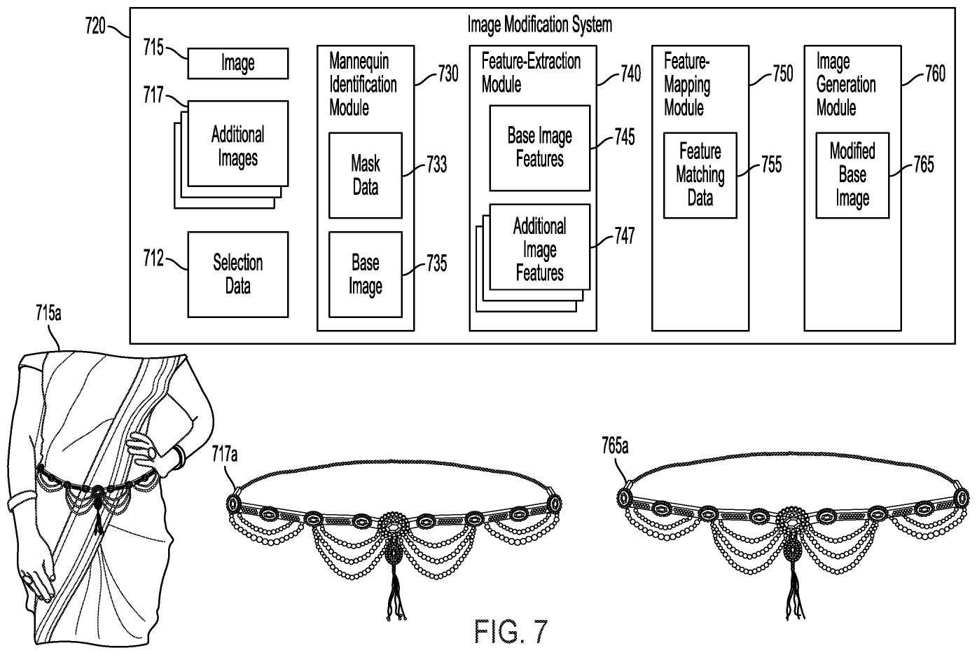

In some implementations, an image modification system is configured to apply a ghost mannequin effect to a selected portion of image data in a base image. For example, the image modification system generates an additional image that depicts a particular selected apparel item, e.g., described by the selected portion of the image data, with the applied ghost mannequin effect. FIG. 7 depicts an example of an image modification system 720 that is configured to generate a modified base image 765 based on a selected image area of an image 715 and one or more additional images 717. The selected image area of the image 715 is indicated, for example, by selection data 712. In some cases, one or more of the image 715, the additional images 717, or the selection data 712 are received from an additional computing system, such as one or more of an online distribution environment or a user computing device (e.g., the user computing device 110). In some cases, the image modification system 720 is included in (or otherwise capable of communicating with) the online distribution environment, such as described in regards to FIG. 1.

In some implementations, one or more of the image 715 or the additional images 717 depict at least one apparel item, such as an apparel item available for distribution via the online distribution environment. In some cases, the image 715 depicts multiple apparel items, such as multiple apparel items displayed on a mannequin. As a non-limiting example, an example image 715a depicts multiple apparel items, such as a sari, bracelets, a ring, and a belt that are worn by a mannequin, such as a professional model. Additionally or alternatively, each of the additional images 717 depicts additional image content describing a particular apparel item depicted in the image 715. As a non-limiting example, an example additional image 717a depicts an additional view of a particular apparel item from the image 715a, such as an additional view of the belt that includes image content depicting a back portion of the belt. In some cases, one or more of the additional images 717 are selected based on the selection data 712. For example, responsive to a determination that the selection data 712 indicates the belt in the example image 715a, the image modification system 720 selects (or otherwise receives) one or more of the additional images 717 depicting the selected apparel item from the image 715a, such as the example additional image 717a of the belt.

In some implementations, the image modification system 720 includes one or more of a mannequin identification module 730, a feature-extraction module 740, the feature-mapping module 750, or an image generation module 760. In FIG. 7, the mannequin identification module 730 identifies one or more areas of the image 715 that depict a mannequin. Additionally or alternatively, the mannequin identification module 730 generates mask data 733 that indicates locations of one or more pixels that represent occluded image areas depicted in the image 715, such as an image area in which a selected apparel item is occluded (or partially occluded) by a mannequin or additional content depicted in the image 715. In some cases, identification of an occluded image area in the image 715 is based upon the selection data 712. For example, responsive to receiving selection data indicating a first apparel item, the mannequin identification module 730 could identify a first occluded image area in the image 715. Additionally or alternatively, responsive to receiving selection data indicating a second apparel item, the mannequin identification module 730 could identify a second occluded image area in the image 715. In some cases, the first occluded image area could include some, none, or all pixels from the second occluded image area. As a non-limiting example, responsive to receiving selection data indicating the belt in the example image 715a, the mannequin identification module 730 could generate first mask data that identifies the sari, the bracelets, the ring, and the professional model as occluded image areas that occlude (or partially occlude) the selected belt. As an additional non-limiting example, responsive to receiving additional selection data indicating the sari in the image 715a, the mannequin identification module 730 could generate second mask data that identifies the bracelets, the ring, the belt, and the professional model as occluded image areas that occlude (or partially occlude) the selected sari.

In some implementations, the mannequin identification module 730 generates a base image 735 based on one or more of the image 715 or the mask data 733. For example, the base image 735 includes digital image data representing the apparel item that is indicated by the selection data 712 and omits digital image data representing the occluded image areas indicated by the mask data 733. In various embodiments, the mannequin identification module 730 can be implemented as one or more of program code, program code executed by processing hardware (e.g., a programmable logic array, a field-programmable gate array), firmware, or some combination thereof.

In some implementations, the feature-extraction module 740 identifies image features of one or more of the base image 735, the additional images 717, or the image 715. For example, the feature-extraction module 740 generates base image features 745 that are extracted from the base image 735. Additionally or alternatively, the feature-extraction module 740 generates additional image features 747 that are extracted from the additional images 717. In some cases, the additional image features 747 include multiple sets of image features, each particular set of image features corresponding to a particular one of the additional images 717. In some cases, the base image features 745 or additional image features 747 could describe image characteristics that are, without limitation, visible to a human viewer, or image characteristics that are not visible (or not readily visible) to a human viewer. In some cases, the feature-extraction module 740 includes one or more neural networks that are configured to identify image features. Additionally or alternatively, the feature-extraction module 740 could be configured (or include one or more neural networks configured) to identify image features based on one or more feature-identification techniques, such as (without limitation) an ORB technique, a SIFT technique, or any other suitable technique or combination of techniques for identifying image features. In various embodiments, the feature-extraction module 740 can be implemented as one or more of program code, program code executed by processing hardware (e.g., a programmable logic array, a field-programmable gate array), firmware, or some combination thereof.

In the image modification system 720, the feature-mapping module 750 determines one or more matching relationships between or among multiple image features. Additionally or alternatively, the feature-mapping module 750 generates feature matching data 755 describing the matching relationships. In some cases, the feature matching data 755 describes matching relationships between pairs of image features that include a particular image feature of the base image 735 and a particular additional feature of one of the additional images 717. For example, the feature-mapping module 750 is configured (or includes one or more neural networks configured) to perform a matching technique that identifies matching features between multiple sets of image features. In FIG. 7, the feature-mapping module 750 is configured to identify one or more pairs of matching features between the base image features 745 and one or more sets of the additional image features 747. In some cases, the feature-mapping module 750 is configured to perform one or more feature-mapping techniques, such as, without limitation, a K-nearest neighbor matching technique, a ratio test, a blockwise homography matching technique, or any other suitable technique or combination of techniques for mapping image features among multiple sets of image features. In some cases, the feature-mapping module 750 is configured to perform one or more feature-mapping verification techniques, such as, without limitation, a multidirectional K-nearest neighbor matching verification technique, a symmetry verification technique, a blockwise homography verification technique, a RANSAC verification technique, or any other suitable technique or combination of techniques for verifying an accuracy of a set of matched image features. In various embodiments, the feature-mapping module 750 can be implanted as one or more of program code, program code executed by processing hardware (e.g., a programmable logic array, a field-programmable gate array), firmware, or some combination thereof.

In some implementations, the image generation module 760 generates a modified base image 765 using one or more of the base image 735, the additional images 717, or the feature matching data 755. In some cases, the image generation module 760 generates the modified base image 765 by combining image data from the base image 735 and image data from at least one of the additional images 717. Additionally or alternatively, the image generation module 760 generates occlusion image data that includes the combination of the modified image data. For example, the image generation module 760 identifies, based on the mask data 733, one or more pixels in the base image 735 that are associated with an occluded image area of the selected apparel item, such as by identifying in the mask data 733 locations of pixels in a mannequin image area. Additionally or alternatively, the image generation module 760 identifies one or more additional pixels in at least one of the additional images 717 that correspond to the occluded pixels of the base image 735. In some cases, the image generation module 760 identifies the correspondence between the occluded pixels and the additional pixels based on the feature matching data 755. For example, using location data for a pair of matching features from the feature matching data 755, the image generation module 760 identifies an occluded pixel that is located in an image area (e.g., a pixel block, an image sub-region localized around the mannequin pixel) that includes a matched feature from the base image features 745. Using the location data of the matching features, the image generation module 760 identifies an additional pixel that is located in an additional image area that includes a matched feature from the additional image features 747. Additionally or alternatively, the image generation module 760 modifies image data of the corresponding occluded pixel to include image data from the additional pixel, such that the modified base image 765 depicts the corresponding occluded pixel with the modified image data from the additional pixel. For example, the modified base image 765 includes the occlusion image data generated by the image generation module 760. In some cases, the image generation module 760 identifies the occluded pixel based on the selection data 712, such as by identifying that a pixel indicated by the selection data 712, e.g., within a selection area of the selected apparel item, is a mannequin pixel.

As a non-limiting example, an example modified base image 765a is generated by combining image data from the base image 735 and the example additional image 717a. The combined image data depicts, for instance, a ghost mannequin effect applied to the selected apparel item in the base image 735. In this example, the image generation module 760 identifies one or more occluded pixels in the base image 735, using location data of pixels included in the mask data 733. The occluded pixels are identified as being associated with a mannequin image area in a selection area around the selected apparel item, such as occluded pixels depicting the sari or the professional model in a selection area around the selected belt. In some cases, the selection area corresponds to a type of the selected apparel item, such as a selection area that has a shape (or other characteristic) that is comparable to a shape or style of the selected apparel item.

Additionally or alternatively, the image generation module 760 identifies one or more additional pixels in the additional image 717a as corresponding to the occluded pixels from the base image 735. For instance, the additional image 717a includes one or more additional pixels corresponding to the occluded pixels in the area of the back of the belt. The correspondence is determined using location data for image features that have a matching relationship (e.g., identified in the feature matching data 755) between a particular feature of the base image 735 and a particular feature of the additional image 717a, such as matching features of the belt fittings or a drape of the belt. For example, the image generation module 760 determines a location (e.g., within the base image 735) of the occluded pixel with respect to a location of one or more pixels depicting a particular feature of the base image 735. Additionally or alternatively, the image generation module 760 determines a location (e.g., within the additional image 717a) of the corresponding pixel with respect to a location of one or more pixels depicting the matching particular feature of the additional image 717a. In some cases, the correspondence of the pixel and the additional pixel is determined, at least in part, using a homography transformation matrix that indicates a location relationship between matching features. For example, if the homography transformation matrix indicates that the particular feature of the additional image 717a has a translated location as compared to the particular feature of the base image 735, such as a translation resulting from a change between images 735 and 717a, the corresponding pixel is identified by applying the translation to the location of the mannequin pixel.

In FIG. 7, the image generation module 760 generates the modified base image 765a by combining image data from the base image 735 with image data from the additional image 717a, such as by modifying the occluded pixel in the back area of the belt to include the image data of the additional pixel from the additional image 717a. The modified base image 765a depicts an example of a ghost mannequin effect applied to a selected portion of image content, such as the selected belt. The ghost mannequin effect includes, for example, a dimensional appearance of the apparel item, such as an arrangement of the belt links or additional fittings, showing a curve of the belt that would fit over a form of a mannequin or person wearing the belt. Additionally or alternatively, the ghost mannequin effect includes occluded areas of the selected apparel item, such as image data depicting the back of the belt that is occluded by the professional model from the example image 715a. In various embodiments, the image generation module 760 can be implemented as one or more of program code, program code executed by processing hardware (e.g., a programmable logic array, a field-programmable gate array), firmware, or some combination thereof.

In some implementations, the image modification system 720 provides the modified base image 765 to one or more additional computing systems. In some cases, the modified base image 765 is provided to a computing system that is configured to display the modified base image 765 via one or more display devices, such as a display device in communication with the user interface 105 of the user computing device 110. Additionally or alternatively, the image modification system 720 provides the modified base image 765 to one or more computing devices of an online distribution environment. For example, the modified base image 765 is provided to a data repository (such as, without limitation, the image repository 102) of the online distribution environment, such that the modified base image 765 is accessible in response to selection inputs (or other inputs) indicating the selected apparel item depicted in the images 715, 717, or 765.

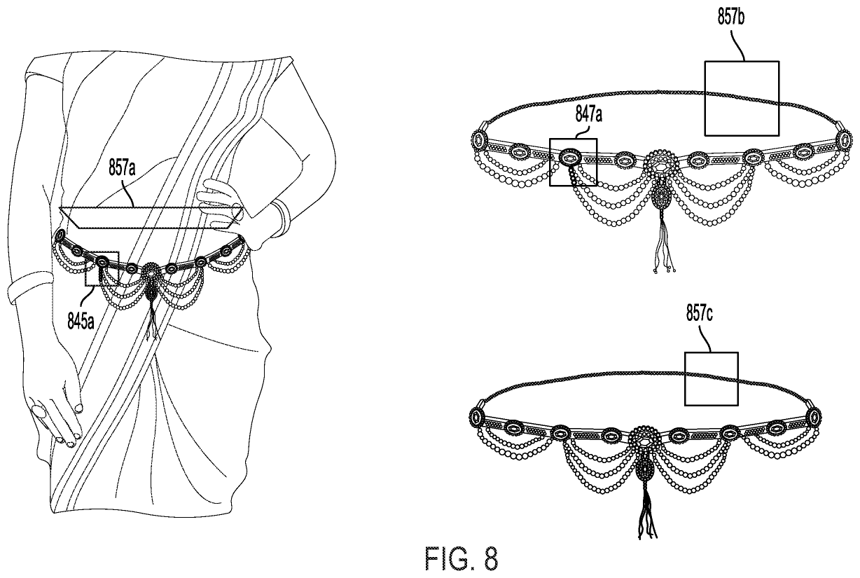

In some implementations, an image modification system is configured to determine one or more matching relationships of features in a selected image area and an additional image. Additionally or alternatively, the image modification system is configured to modify an occluded pixel of a selected image area to include image data of an additional pixel in the additional image. FIG. 8 depicts an example of occluded pixels for a selected image area depicting a selected apparel item. The occluded pixels in FIG. 8 are modified, for example, to include image data from additional pixels in an additional image. For example, and not by way of limitation, the image modification system 720 could use one of more of the techniques described in regards to FIG. 4, 5, or 8 to generate the modified base image 765.

In FIG. 8, one or more image features, such as an image feature 845a or an additional image feature 847a, are extracted from a digital image, such as one or more of a base image or an additional image. In some cases, a feature-extraction module, such as the feature-extraction module 740, extracts the features 845a and 847a from, respectively, the base image 735 and the additional images 717. For example, the image feature 845a is included in the base image features 745 and is extracted from the base image 735. The image feature 845a depicts, for example, a feature indicating an arrangement of the selected apparel item (e.g., an arrangement of belt links). Additionally or alternatively, the additional image feature 847a is included in a particular set of the additional image features 747 and is extracted from a particular one of the additional images 717 corresponding to the particular set of the additional image features 747. The additional image feature 847a depicts, for example, an arrangement of the selected apparel item. For convenience, and not by way of limitation, the features 845a and 847a features that are visible to a human viewer (e.g., a person observing the example images 715a or 717a), but other implementations are possible, including extraction of or determining matching relationships among features that are not perceptible by a human viewer.

In some implementations, a feature-mapping module, such as the feature-mapping module 750, performs one or more feature-mapping techniques based on the sets of image features 745 and 747, including the image features 845a and 847a. For example, the feature-mapping module 750 performs one or more of a K-nearest neighbor matching technique, a multidirectional K-nearest neighbor matching technique, a ratio test, or a blockwise homography technique, as described elsewhere herein. Additionally or alternatively, the feature-mapping module 750 applies the feature-mapping techniques to a subset of features from the sets 745 and 747, such as a subset including selected pixel blocks that have a threshold quantity of neighbor blocks that are within a threshold distance from the selected pixel blocks. In some cases, the feature-mapping module 750 identifies a group of potential matching image features by applying the example K-nearest neighbor matching technique to the sets of image features 745 and 747. For example, the feature-mapping module 750 (or an included classification neural network) compares a visual similarity between image features to a feature similarity threshold. Additionally or alternatively, the feature-mapping module 750 identifies a matching relationship between the features 845a and 847a based on the example ratio test. For example, the feature-mapping module 750 determines distances between the image feature 845a and others of the base image features 745, and additional distances between the additional image feature 847a and others of the additional image features 747. Additionally or alternatively, the feature-mapping module 750 determines a ratio of the distances for the feature 845a and the additional distances for the feature 847a.

In FIG. 8, the example blockwise homography technique is applied to the image features 845a and 847a. For example, the feature-mapping module 750 generates (or modifies) the feature matching data 755 to include a homography transformation matrix indicating one or more homographic mappings of image features from the base image 735 and additional image features from one or more of the additional images 717.

In some implementations, the image modification system 720 determines one or more pixels in the selected image area that are occluded. For example, the image generation module 760 identifies, using pixel location data in the mask data 733, one or more occluded pixels 857a that are included in the base image 735. In some cases, the occluded pixels 857a represent image data of occluded portions of the selected apparel item, such as pixels depicting fabric of the sari or the hand of the professional model. Additionally or alternatively, the image generation module 760 determines that one or more of the occluded pixels 857a correspond to one or more additional pixels included in an additional image, such as pixels 857b included in the additional image 717a. For example, based on the matching relationships between the image features 745 and the additional image features 747, the image generation module 760 determines the correspondence between the pixels 857a and 857b, such as by determining location data of the pixels 857a and 857b with respect to location data of pixels for matching features of the feature sets 745 and 747. In some cases, the correspondence is determined, at least in part, by applying a location relationship indicated by the homography transformation matrix included in the feature matching data 755. For example, if the homography transformation matrix indicates a transformation between the image feature 845a and the additional image feature 847a, the image generation module 760 could apply the transformation to the occluded pixels 857a. Additionally or alternatively, the image generation module 760 identifies the corresponding pixels 857b by applying the transformation to the occluded pixels 857a. In this example, the homography transformation matrix indicates a location relationship (e.g., a transformed location) of the additional pixels 857b as compared to the occluded pixels 857a.

In FIG. 8, the image generation module 760 generates one or more pixels 857c based on a combination of the occluded pixels 857a and the additional pixels 857b. For example, the image generation module 760 generates (or modifies) the modified base image 755a to include the modified pixels 857c. The modified pixels 857c include a combination of image data from the pixels 857a and 857b, such as location data of the occluded pixels 857a within the modified image 765a and image content data of the additional pixels 857b. As a non-limiting example, the modified pixels 857c have locations within the occluded areas of the base image 735 and image content depicting the back portion of the belt occluded by the sari and professional model in the image 715a. In some cases, the modified pixels 857c depict a ghost mannequin effect in the modified base image 765a, such as a dimensional appearance of the selected apparel item, e.g., the belt, combined with image data depicting occluded areas of the selected apparel item.

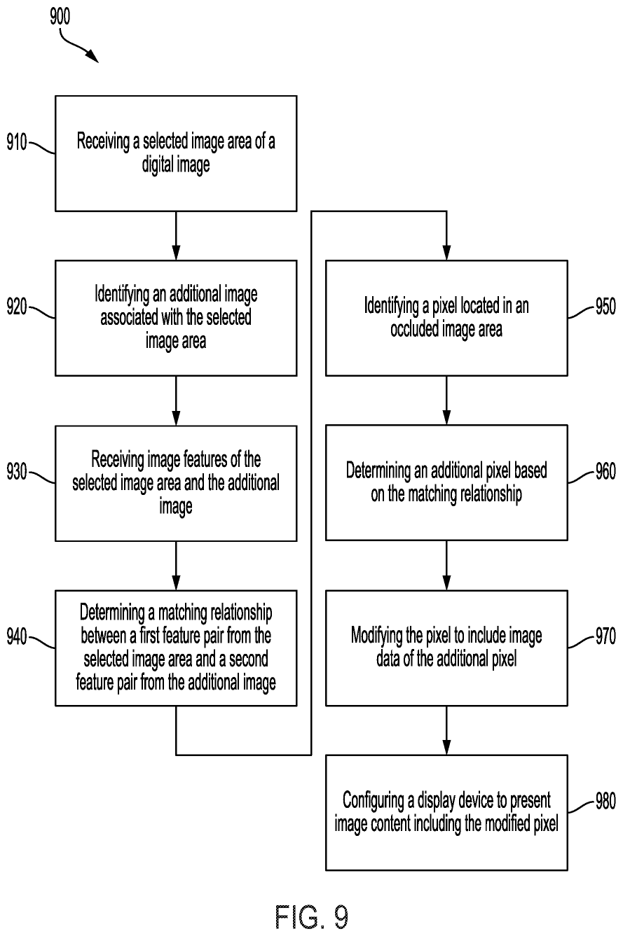

FIG. 9 is a flowchart depicting an example of a process 900 for applying a ghost mannequin effect to selected image data of a digital image depicting one or more apparel items. In some embodiments, such as described in regards to FIGS. 1-8, a computing device executing an image modification system implements operations described in FIG. 9, by executing suitable program code. For illustrative purposes, the process 900 is described with reference to the examples depicted in FIGS. 1-8. Other implementations, however, are possible. In some embodiments, one or more operations described herein with respect to the process 900 can be used to implement one or more steps for generating an image with an applied ghost mannequin effect.

At block 910, the process 900 involves receiving a selected image area, such as an image area of a digital image. In some cases, the digital image depicts one or more apparel items. Additionally or alternatively, the selected image area indicates data depicting a particular one of the apparel items of the digital image. In some implementations, one or more modules of an image modification system, such as a mannequin identification module or a feature-extraction module, receive selection data that indicates one or more of the digital image or the selected image area. For example, the mannequin identification module 730 receives the selection data 712 indicating a selected image area of the image 715. In some cases, the mannequin identification module 730 generates one or more of the mask data 733 or the base image 735 responsive to the indication of the selected area of the image 715.

At block 920, the process 900 involves identifying an additional image associated with the selected image area. For example, the mannequin identification module receives one or more additional images including image content depicting additional portions or views of the particular apparel item that is depicted by the selected image area. In some cases, the mannequin identification module identifies the one or more additional images based on the selected image area. For example, the mannequin identification module 730 identifies one or more of the additional images 717 as being associated with the selected image area of the image 715, such as an identification responsive to the selection data 712.

At block 930, the process 900 involves receiving image features of one or more of the selected image area or the additional image. In some implementations, the feature-extraction module of the image modification system generates (or otherwise receives) image features corresponding to the selected image area or a base image that is generated from the selected image area. Additionally or alternatively, the feature-extraction module generates (or otherwise receives) additional image features corresponding to the additional image. In some cases, the additional image features are included in a group of multiple sets of additional image features, each one of the sets corresponding to a particular additional image. For example, the feature-extraction module 740 extracts the base image features 745 from the base image 735 depicting the selected image area. Additionally or alternatively, the feature-extraction module 740 extracts each set of the additional image features 747 from, respectively, each of the additional images 717. In some implementations, a feature-mapping module of the image modification system receives the image features and one or more sets of the additional image features. For example, the feature-mapping module 750 receives the base image features 745 and the additional image features 747. Additionally or alternatively, one or more of the image features or the additional image features are received from an additional computing system that is configured to identify image features of digital images.

At block 940, the process 900 involves determining a matching relationship between a first feature pair, such as from the selected image area, and a second feature pair, such as from the additional image. In some cases, the feature-mapping module determines the matching relationship based on a first distance between the first feature pair and a second distance between the second feature pair. For example, the matching relationship is determined by comparing a ratio including the first and second distances to a feature similarity threshold. Additionally or alternatively, the feature-mapping module generates (or modifies) feature matching data to indicate the matching relationship. For example, the feature-mapping module 750 determines a matching relationship between (or among) a first set of image features and a second set of additional image features. The first set of image features, for example, are included in the base image features 745 and the second set of additional image features are included in a particular set of the additional image features 747. Additionally or alternatively, the feature-mapping module 750 generates (or modifies) the feature matching data 755 to indicate the matching relationship of the first set of image features and the second set of additional image features. In some implementations, the matching relationship is determined using one or more feature-mapping techniques, such as, without limitation, a ratio test or a blockwise homography matching technique. Additionally or alternatively, one or more matching relationships are verified using one or more feature-mapping verification techniques, such as, without limitation, a multidirectional K-nearest neighbor verification technique, a symmetry verification technique, or a blockwise homography verification technique.

In some implementations operations related to one or more of blocks 910, 920, 930, or 940 are repeated. For example, the feature-extraction module 740 could extract a set of the additional image features 747 for each image of the additional images 717. Additionally or alternatively, the feature-mapping module 750 could determine multiple feature sets from the base image features 745 or one or more of the sets of additional image features 747, or calculate multiple respective distances between (or among) the multiple feature sets. Furthermore, the feature-mapping module 750 could determine multiple matching relationships between (or among) multiple feature sets, such as multiple matching relationships between multiple feature sets from the base image features 745 and multiple feature sets from a particular set of the additional image features 747, or between multiple feature sets from the base image features 745 and multiple feature sets from multiple sets of the additional image features 747.

At block 950, the process 900 involves identifying a pixel that is located in an occluded image area, such as one or more occluded pixels. In some cases, an image generation module of the image modification system identifies the occluded pixel using pixel locations indicated by mask data. The mask data indicates one or more of, for example, pixels depicting the selected apparel item or occluded pixels depicting one or more of a mannequin or additional apparel items (e.g., non-selected apparel items) in the selected image area. For example, the mask data 733 indicates occluded pixels associated with areas of the example image 715a depicting the sari, bracelets, ring, or professional model. Additionally or alternatively, the image generation module 760 identifies one or more occluded pixels from the base image 735 using pixel locations indicated by the mask data 733.

At block 960, the process 900 involves determining that the pixel corresponds to an additional pixel that is included in the additional image. Additionally or alternatively, the correspondence between the pixel and the additional pixel is determined based on the matching relationship. For example, using location data of a set of features having a matching relationship, such as the first feature pair and the second feature pair, the image generation module identifies an additional pixel corresponds to the occluded pixel. In some cases, the occluded pixel is within an image area of the first feature pair (e.g., within the base image depicting the selected apparel item) and the additional pixel is within an image area of the second feature pair (e.g., within the additional image). For example, the image generation module 760 determines that an occluded pixel from the base image 735 corresponds to an additional pixel from a particular one of the additional images 717. Additionally or alternatively, the image generation module 760 identifies the correspondence of the pixels using location data of the first feature set and the second feature set having the matching relationship, such as the matching relationship described in the feature matching data 755. For example, using location data for the first feature set in the base image 735, the image generation module 760 identifies an occluded pixel that is located in an image area that includes the first feature set. Using the location data of the matching features, e.g., the second feature set, the image generation module 760 identifies an additional pixel that is located in an additional image area that includes the second feature set. In some cases, one or more operations described with respect to block 960 can be used to implement a step for generating occlusion image data from corresponding image data that is identified based on matching relationship between a first pair of image features and a second pair of additional image features.

At block 970, the process 900 involves modifying the pixel to include image data of the additional pixel. In some cases, the base image in which the pixel is included is modified, such as to include a ghost mannequin effect applied to the selected apparel item. For example, the image generation module modifies the base image (e.g., generates a modified base image) to include, at the location of the occluded pixel, image data from the additional pixel. Additionally or alternatively, the modified base image depicts a ghost mannequin effect applied to image content of the base image, such as a ghost mannequin effect applied to the selected apparel item. For example, the image generation module 760 generates the modified base image 765 by combining image data from the base image 735 and image data from a particular one of the additional images 717. The modified base image 765 depicts image content with an applied ghost mannequin effect, such as the ghost mannequin effect applied to the selected belt depicted in the example modified base image 765a. In some cases, the ghost mannequin effect includes a dimensional appearance of the selected apparel item combined with additional image data depicting occluded areas of the selected apparel item, such as the shape of the belt from the example base image 715a combined with image data, from the example additional image 717a, depicting the back portion of the belt. In some cases, one or more operations described with respect to block 970 can be used to implement a step for generating occlusion image data from corresponding image data that is identified based on a matching relationship between a first pair of image features and a second pair of additional image features. For example, the occlusion image data includes a combination of image data from a base image and an additional image, such as combined image data that indicates a pixel location of the occluded pixel and image data of the corresponding additional pixel. In some cases, the combination of image data is identified based on a matching relationship between features of the base image and additional features of the additional image, such as by identifying a location of the occluded pixel with respect to the first pair of the image features and an additional location of the corresponding additional pixel with respect to the second pair of the image features. Additionally or alternatively, the correspondence of the pixel and the additional pixel is determined, at least in part, by using a homography transformation matrix that indicates a location relationship between matching features. For example, if the homography transformation matrix indicates that the second pair of features has a transformed (e.g., skewed, rotated, laterally translated) location as compared to the first pair of features, the corresponding pixel is identified by applying the translation to the location of the occluded pixel.

In some implementations, or operations related to one or more of blocks 950, 960, or 970 are repeated. For example, the image generation module 760 could identify multiple occluded pixels in the base image 735. Additionally or alternatively, the image generation module 760 could determine multiple additional pixels corresponding to the multiple occluded pixels, or identify respective image data for the multiple additional pixels. Furthermore, the image generation module 760 could modify multiple pixels of the base image 735. For example, the modified base image 765 could include multiple modified pixels corresponding to some, all, or none of occluded areas (e.g., mannequin pixels) of the selected apparel item depicted in the base image 735 or the image 715.

At block 980, the process 900 involves configuring a display device to present image content including the modified pixel. For example, the image modification system generates display data describing the modified base image. Additionally or alternatively, the image modification system provides the display data to one or more additional computing systems. For example, the image generation module 760 (or another module of the image modification system 720) generates display data describing the modified base image 765. Additionally or alternatively, the image modification system 720 provides the display data to one or more of an online distribution environment or a user device (such as described in regards to FIG. 1).

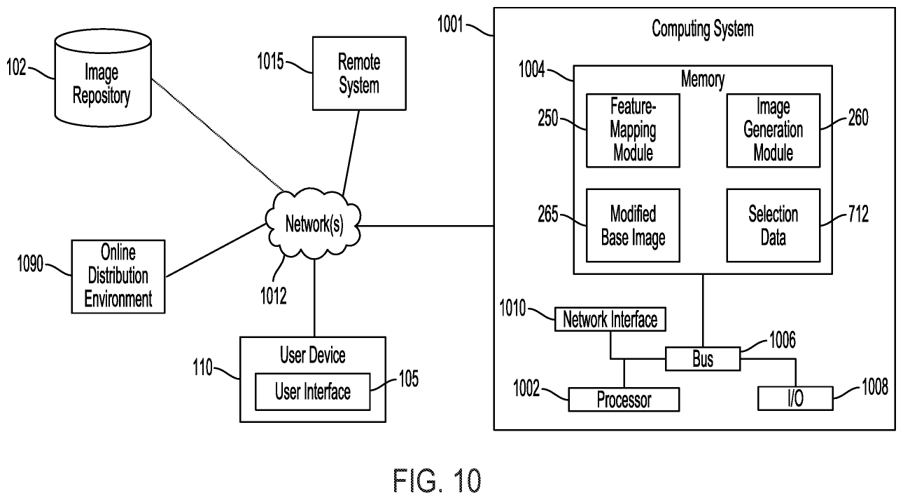

Any suitable computing system or group of computing systems can be used for performing the operations described herein. For example, FIG. 10 is a block diagram depicting a computing system capable of implementing an image modification system, according to certain embodiments.

The depicted example of a computing system 1001 includes one or more processors 1002 communicatively coupled to one or more memory devices 1004. The processor 1002 executes computer-executable program code or accesses information stored in the memory device 1004. Examples of processor 1002 include a microprocessor, an application-specific integrated circuit (“ASIC”), a field-programmable gate array (“FPGA”), or other suitable processing device. The processor 1002 can include any number of processing devices, including one.

The memory device 1004 includes any suitable non-transitory computer-readable medium for storing the feature-mapping module 250, the image generation module 260, the modified base image 265, the selection data 712, and other received or determined values or data objects. The computer-readable medium can include any electronic, optical, magnetic, or other storage device capable of providing a processor with computer-readable instructions or other program code. Non-limiting examples of a computer-readable medium include a magnetic disk, a memory chip, a read-only memory (“ROM”), a random-access memory (“RAM”), an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 1001 may also include a number of external or internal devices such as input or output devices. For example, the computing system 1001 is shown with an input/output (“I/O”) interface 1008 that can receive input from input devices or provide output to output devices. A bus 1006 can also be included in the computing system 1001. The bus 1006 can communicatively couple one or more components of the computing system 1001.

The computing system 1001 executes program code that configures the processor 1002 to perform one or more of the operations described above with respect to FIGS. 1-9. The program code includes operations related to, for example, one or more of the feature-mapping module 250, the image generation module 260, the modified base image 265, the selection data 712 or other suitable applications or memory structures that perform one or more operations described herein. The program code may be resident in the memory device 1004 or any suitable computer-readable medium and may be executed by the processor 1002 or any other suitable processor. In some embodiments, the program code described above, the feature-mapping module 250, the image generation module 260, the modified base image 265, and the selection data 712 are stored in the memory device 1004, as depicted in FIG. 10. In additional or alternative embodiments, one or more of the feature-mapping module 250, the image generation module 260, the modified base image 265, the selection data 712, and the program code described above are stored in one or more memory devices accessible via a data network, such as a memory device accessible via a cloud service.

The computing system 1001 depicted in FIG. 10 also includes at least one network interface 1010. The network interface 1010 includes any device or group of devices suitable for establishing a wired or wireless data connection to one or more data networks 1012. Non-limiting examples of the network interface 1010 include an Ethernet network adapter, a modem, and/or the like. A remote system 1015 is connected to the computing system 1001 via network 1012, and remote system 1015 can perform some of the operations described herein, such as generating mask data or extracting image features. The computing system 1001 is able to communicate with one or more of the remote computing system 1015, the user device 110, the image repository 102, or an online distribution environment 1090 using the network interface 1010. Although FIG. 10 depicts the image repository 102 as connected to computing system 1001 via the networks 1012, other embodiments are possible, including the image repository 102 running as a program in the memory 1004 of the computing system 1001, or as a component of the online distribution environment 1090.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A system for generating a ghost mannequin effect within a digital image, the system comprising:
a feature-mapping module configured for:
receiving image features of a base image and receiving additional image features of an additional image, wherein the base image and the additional image depict an apparel item;
determining a first pair of the image features of the base image and a second pair of the additional image features of the additional image;
calculating a first distance between the first pair of the image features and a second distance between the second pair of the additional image features; and
determining, based on the first distance and the second distance, a matching relationship that exists between the first pair of the image features and the second pair of the additional image features;
and
an image generation module configured for:
identifying, in the base image, a pixel located within a mannequin image area;
determining, based on the matching relationship, that the pixel corresponds to an additional pixel that is included in the additional image;
identifying image data of the additional pixel; and
modifying the base image to include a ghost mannequin effect by modifying the pixel to include the image data of the additional pixel.

2. The system of claim 1, further comprising a mannequin identification module configured for:
determining that the pixel includes additional image data describing a mannequin depicted by the base image; and
generating a digital image mask indicating the pixel, wherein identifying the pixel located within the mannequin image area is based on the digital image mask.

3. The system of claim 2, wherein the mannequin identification module is further configured for modifying the pixel to omit the additional image data describing the mannequin depicted by the base image.

4. The system of claim 1, further comprising a feature-extraction module configured for:
extracting, from the base image, the image features; and
extracting, from the additional image, the additional image features.

5. The system of claim 1, wherein the feature-mapping module is further configured for:
determining a visual similarity between the first pair of the image features and the second pair of the additional image features by applying a classification neural network to the image features of the base image and to the additional image features of the additional image; and
comparing the visual similarity to a feature similarity threshold,
wherein calculating the first distance and the second distance is responsive to determining that the visual similarity exceeds the feature similarity threshold.

6. The system of claim 1, wherein the feature-mapping module is further configured for:
determining a third pair of the image features of the base image and a fourth pair of the additional image features of the additional image,
wherein a particular image feature is included in the first pair and the third pair of the image features and wherein a particular additional image feature is included in the second pair and the fourth pair of the image features;
calculating a third distance between the third pair of the image features and a fourth distance between the fourth pair of the additional image features, wherein the first distance and the third distance are based on the particular image feature and wherein the second distance and the fourth distance are based on the particular additional image feature; and
calculating a first ratio between the first distance and the third distance and a second ratio between the second distance and the fourth distance,
wherein determining the matching relationship is based on a comparison of the first ratio with the second ratio.

7. The system of claim 1, wherein the feature-mapping module is further configured for, responsive to determining the matching relationship, identifying a homography transformation matrix for a block of pixels including the first pair of the image features,
wherein correspondence between the pixel and the additional pixel is indicated by the homography transformation matrix.

8. A method for generating a ghost mannequin effect for an area of digital image content, the method comprising:
receiving a selected image area of a digital image;
identifying an additional image associated with the selected image area;
receiving image features of the selected image area and additional image features of the additional image;
determining a matching relationship between (i) a first pair of the image features of the selected image area and (ii) a second pair of the additional image features of the additional image;
identifying, in the selected image area, a pixel located within an occluded image area;
determining, based on the matching relationship, that the pixel corresponds to an additional pixel that is included in the additional image;
modifying the pixel to include image data of the additional pixel; and
configuring a display device to present digital image content that includes the modified pixel.

9. The method of claim 8, wherein the digital image includes multiple image areas, each of the multiple image areas depicting a respective apparel item, wherein the selected image area is included in the multiple image areas.

10. The method of claim 8, further comprising receiving a user input indicating the selected image area.

11. The method of claim 8, further comprising calculating a first distance between the first pair of the image features and a second distance between the second pair of the additional image features,
wherein determining the matching relationship is based on the first distance and the second distance.

12. The method of claim 11, further comprising:
determining a visual similarity between the first pair of the image features and the second pair of the additional image features by applying a classification neural network to the image features of the selected image area and to the additional image features of the additional image; and
comparing the visual similarity to a feature similarity threshold,
wherein calculating the first distance and the second distance is responsive to determining that the visual similarity exceeds the feature similarity threshold.

13. The method of claim 8, further comprising:
determining a third pair of the image features of the selected image area and a fourth pair of the additional image features of the additional image;
calculating (i) a first distance between the first pair of the image features, (ii) a second distance between the second pair of the additional image features, (iii) a third distance between the third pair of the image features, and (iv) a fourth distance between the fourth pair of the additional image features; and
calculating a first ratio between the first distance and the third distance and a second ratio between the second distance and the fourth distance,
wherein determining the matching relationship is based on a comparison of the first ratio with the second ratio.

14. The method of claim 8, further comprising:
responsive to determining the matching relationship, identifying a homography transformation matrix for a block of pixels including the first pair of the image features,
wherein correspondence between the pixel and the additional pixel is indicated by the homography transformation matrix.

15. A non-transitory computer-readable medium embodying program code for generating a ghost mannequin effect within a digital image, the program code comprising instructions which, when executed by a processor, cause the processor to perform operations comprising:
receiving image features of a base image and receiving additional image features of an additional image;
a step for generating occlusion image data from corresponding image data of the additional image, the corresponding image data identified based on a matching relationship between a first pair of the image features and a second pair of the additional image features; and
modifying a pixel in an occluded area of the base image, the pixel being modified to include the occlusion image data.

16. The non-transitory computer-readable medium of claim 15, the operations further comprising:
calculating a first distance between the first pair of the image features and a second distance between the second pair of the additional image features; and
determining the matching relationship based on the first distance and the second distance.

17. The non-transitory computer-readable medium of claim 16, the operations further comprising:
determining a visual similarity between the first pair of the image features and the second pair of the additional image features by applying a classification neural network to the image features of the base image and to the additional image features of the additional image; and
comparing the visual similarity to a feature similarity threshold,
wherein calculating the first distance and the second distance is responsive to determining that the visual similarity exceeds the feature similarity threshold.

18. The non-transitory computer-readable medium of claim 15, the operations further comprising:
determining a third pair of the image features of the base image and a fourth pair of the additional image features of the additional image;
calculating (i) a first distance between the first pair of the image features, (ii) a second distance between the second pair of the additional image features, (iii) a third distance between the third pair of the image features, and (iv) a fourth distance between the fourth pair of the additional image features; and
calculating a first ratio between the first distance and the third distance and a second ratio between the second distance and the fourth distance,
wherein the matching relationship is determined based on a comparison of the first ratio with the second ratio.

19. The non-transitory computer-readable medium of claim 15, the operations further comprising:
identifying, responsive to determining the matching relationship, a homography transformation matrix for a block of pixels in the base image, the block of pixels including the first pair of the image features,
wherein the homography transformation matrix indicates a homographic mapping between the block of pixels and an additional block of pixels in the additional image; and
identifying a location relationship, within the base image, between the block of pixels and the pixel in the occluded area, based on the homographic mapping,
wherein the corresponding image data is identified by applying the location relationship to the additional block of pixels and an additional pixel in the additional image.

20. The non-transitory computer-readable medium of claim 15, the operations further comprising:
identifying, in the base image, additional image data describing a mannequin depicted by the base image; and
generating a digital image mask indicating one or more pixels depicting the additional image data, wherein the pixel in the occluded area is identified based on the digital image mask.
